(19) United States
(12) Patent Application Publication
(10) Pub. No.: US 2014/0363781 A1
(43) Pub. Date: Dec. 11, 2014

(54) Orthodontic Appliance

(71) Applicant: Christopher John Farrell, Helensvale (AU)

(72) Inventor: Christopher John Farrell, Helensvale (AU)

(21) Appl. No.: 14/470,900

(22) Filed: Aug. 27, 2014

Related U.S. Application Data
(62) Division of application No. 13/668,677, filed on Nov. 5, 2012, now abandoned.
Application No. 13/668,677 is a continuation-in-part of application No. 12/669,993, filed on Jan. 21, 2010, now abandoned.

(30) Foreign Application Priority Data
Aug. 29, 2007 (AU) 2007904670

(51) Int. Cl. A61C 7/36; A61C 7/10; A61C 7/08

(52) U.S. Cl. CPC A61C 7/36; A61C 7/08; A61C 7/10
USPC 433/6

(57) ABSTRACT

An orthodontic appliance having an outer wall and an inner wall, and a web extending between the inner and the outer walls for treating a class three malocclusion is disclosed. The inner and outer walls and the web define upper and lower channels within which the respective arches of a patient can be received. The inner and outer walls form a mounting arrangement for mounting the appliance on the upper and lower arches of the patient. The outer wall has an upper portion which is offset relative to the lower portion and the upper portion forms an outer spacing formation for holding the buccal mucosa away from the patient's upper arch so that it does not inhibit development of the upper arch. The appliance also includes a tongue elevator for lifting up the tongue to a height above the lower arch.

This Application is a divisional of U.S. application Ser. No. 13/668,677, filed Nov. 5, 2012, which is a continuation in part of U.S. application Ser. No. 12/669,993 filed Jan. 21, 2010, which is a 35 U.S.C. §371 application of International Application No. PCT/AU2008/001293, filed Aug. 29, 2008, the entire content of all of which is incorporated herein by reference.

### FIELD

This invention relates to an orthodontic appliance.

This invention relates particularly but not exclusively to an active orthodontic appliance for use in the treatment of a Class 3 malocclusion. It will therefore be convenient to hereinafter describe the invention with reference to this example application. However at the same time it is to be clearly understood that the invention is capable of broader application. For example the appliance may also have application in the treatment of other conditions and other types of malocclusions. Further the orthodontic appliance can also be used as a functional orthodontic appliance and as a passive orthodontic appliance.

### BACKGROUND

Humans have an upper jaw called a maxilla forming an upper arch and a hinged lower jaw called a mandible forming a lower arch. A patient has correct dental occlusion when the upper arch matches the size and shape of the lower arch such that the teeth of the upper and lower jaw come together when the jaws are closed. Further with correct occlusion individual teeth of the upper and lower arch are positioned along the length of the arch relative to each other such that they fit together correctly.

However while the upper and lower arches are broadly of the same size they are subtly offset relative to each other. Specifically the teeth of the upper arch are offset relative to the teeth of the lower arch so that at least part of each tooth of the upper arch is positioned outward of the corresponding tooth on the lower arch. Further the incisors of the lower arch are positioned behind the incisors of the upper arch.

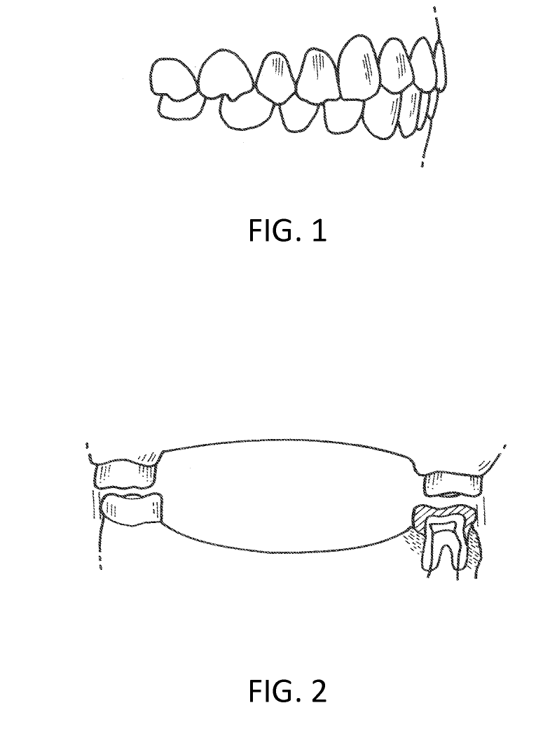

FIGS. 1 and 2 are respectively a side view and a rear view of a user's upper and lower arches showing correct dental occlusion. FIG. 1 clearly shows the incisors of the upper jaw positioned forward of the incisors of the lower jaw. Further the rear view shows the offset of the teeth of the lower jaw relative to the upper jaw in the region of the rear molars.

However malocclusions which involve a mismatch in the sizes of the upper and lower jaw are a relatively common condition in human populations around the world.

A Class 2 malocclusion occurs when the upper jaw of a patient is larger than the lower jaw. This is caused by a lack of development in the lower jaw of a user resulting in a lower jaw with a smaller arch than the upper jaw. A consequence of this is that the teeth of the upper jaw project out anteriorly proud of the teeth of the lower jaw producing a deep bite curve between the teeth of the upper and lower jaws. Caucasian populations are particularly prone to a Class 2 malocclusion.

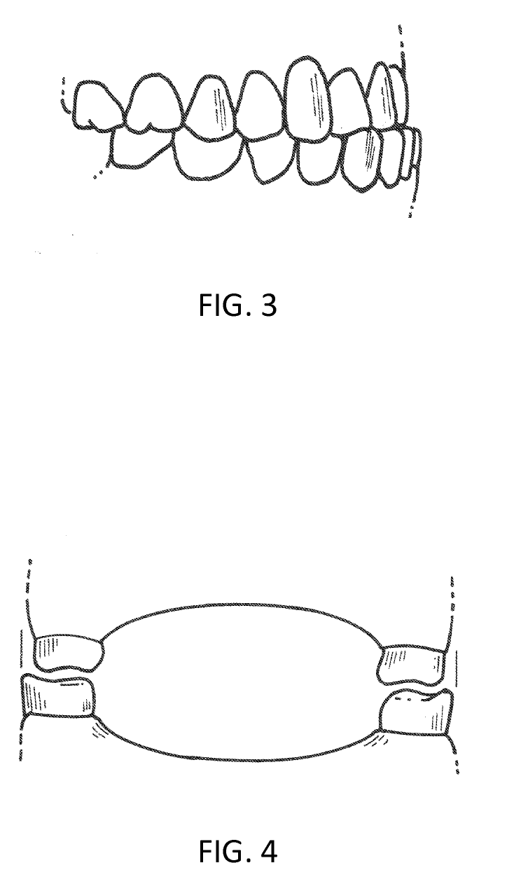

Another type of malocclusion is a Class 3 malocclusion in which the lower arch is more developed than the upper arch and does not correctly match the size of the upper arch. Typically a patient with a class 3 malocclusion has a mid facial region that is underdeveloped, e.g. the anterior region of the maxilla on the upper arch is underdeveloped and is positioned behind the anterior region of the lower arch. This can cause the anterior incisor teeth of the lower arch to project out anteriorly proud of the incisor teeth of the upper arch as shown in FIG. 3 of the drawings. As discussed above for correct dental occlusion, the incisors of the lower arch should be received behind those of the upper arch with an offset of about 2 mm.

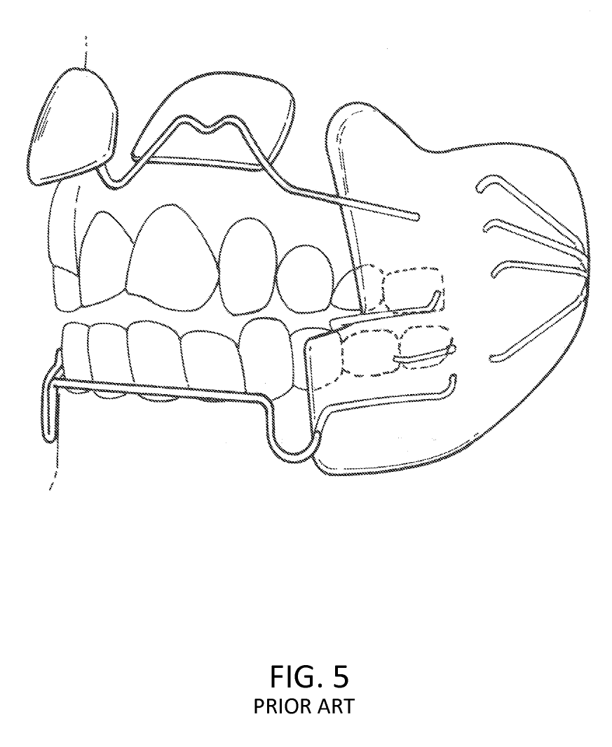

A class 3 malocclusion may extend lengthwise along the arch and affect the canine regions and the molar regions as well as the incisor region. For example the molar region of the upper arch may be underdeveloped and of narrower width than that of the lower arch. The mismatch of the upper and lower arches in the molar region of a patient is shown in FIG. 4 of the drawings. Class 3 malocclusions are particularly common in Asian populations around the world.

Essentially the class 3 malocclusion is caused by a mismatch in the growth of the maxilla and mandible in the developmental stages of a child's growth. This can be caused by myofunctional habits that encourage growth inhibiting forces to be applied to structures of the upper arch and growth promoting forces to be applied to structures of the lower arch. For example the tongue can apply a considerable pressure to the lower arch to promote its development. Further the lips and cheeks of a user can apply a considerable inward pressure to the arch, e.g. the upper arch of a user, to retard or inhibit development of the upper arch.

The most common modality for treatment of class 3 malocclusions is surgical intervention. This surgery involves surgical alteration of the maxilla and the mandible so that the upper and lower arches match each other. However this surgery is complex and needs to be carried out by highly skilled and specialized surgeons. As such it is only accessible to wealthy populations in developed countries around the world and this has limited its application. This application has been further limited in recent times as state budgets have come under pressure and the expenditure on this type of surgery has been reined in. Aside from this some shortcomings of this treatment modality are that the treatment is very aggressive and invasive and also the results obtained by using surgery have been very disappointing.

Another problem is that it would simply not be practical to train sufficient surgeons to treat all the class 3 malocclusions occurring within the population of an Asian country such as China. Therefore maxilla-facial surgery is not a solution to this problem and another solution has to be sought.

Another way of treating a class 3 malocclusion is to use an appliance known as a Frankel appliance of the type shown in FIG. 5. The Frankel appliance is custom built to fit the arches and mouth of a patient by taking bite impressions of a patient's arches and dentition and then building a model of the patient's arches. An appliance that is sized and shaped to be positioned on the upper and lower arches of a particular user is built up from this bite model in a dental laboratory. The appliance is designed to hold the buccal mucosa away from the upper arch in the patient's cheek region. However the results obtained by treating a Class 3 malocclusion with such a Frankel appliance have been mixed. In Applicant's experience a mid-facial region, or anterior incisor region of the upper arch often remains underdeveloped after treatment with a Frankel appliance. Further the time taken to treat a Class 3 malocclusion with a Frankel appliance can be unduly long and it can be hard to see progress being made along the way.

Yet another treatment option is to use an external band that is resilient and is passed around the head of the patient. The band is passed over the chin over the patient and thus applies a rearward pressure to the mandible of the patient with the aim of inhibiting development of the mandible. It will immediately be appreciated that this does not promote any development of the upper arch particularly in the mid-facial region thereof which is a significant part of the problem with a class 3 malocclusion. As far as the Applicant is aware the treatment results achieved with this head band have been poor. In any event this treatment option does not provide a complete solution to a class 3 malocclusion because it does not treat the underdeveloped upper arch of a class 3.

A further problem is that the treatment modalities described above, in particular surgery, are generally not available to general populations in developing countries in Asia such as China. Consequently many class 3 malocclusions in these regions are untreated because there are no practical and accessible treatment options available to ordinary patients within the general population at large. This is severely affecting the quality of life of patients with this malocclusion as the malocclusion is aesthetically unattractive and impacts the ability of patients to eat and chew food effectively.

Clearly therefore it would be advantageous if a practical and accessible modality for the treatment of class 3 malocclusions could be devised that could be made available on a wide scale to patients in developing as well as developed countries. It would be particularly advantageous if this option was less aggressive and less invasive than the prior art maxilla-facial surgery practised in the prior art. It would also be advantageous if a treatment could be devised which simultaneously addressed both underdevelopment of the upper arch and overdevelopment of the lower arch. Yet further it would be advantageous if the treatment times for treating class 3 malocclusions in developing children could be reduced.

### SUMMARY OF THE DISCLOSURE

According to one aspect there is provided an orthodontic appliance, e.g. for treating a class 3 malocclusion in a patient, having an upper and a lower arch, the appliance comprising:

an outer wall and an inner wall, and a web extending between the inner and the outer walls forming a lower web surface and an upper web surface, the outer wall, inner wall and web define an upper channel within which the upper arch can be received and a lower channel within which the lower arch can be received,

the outer wall and the inner wall form a mounting arrangement for mounting the appliance on the upper and lower arches,

the outer wall has an upper portion above the web defining an outer wall upper channel surface and a lower portion below the web defining an outer wall lower channel surface, the upper web surface has a greater width between the inner and outer walls than the lower web surface, and the outer wall upper channel surface is vertically off-set from the outer wall lower channel surface across the canines and incisors of the patient, with the outer wall lower channel surface set back from the outer wall upper channel surface,

wherein the upper portion of the outer wall holds the buccal mucosa spaced away from the patient's upper arch, and the width of the upper web surface accommodates development of the upper arch during treatment; and

a tongue elevator positioned beneath the lower web surface for forcing the patient's tongue up to a height above their lower arch.

The outer and inner walls may include a frontal incisor region extending across the incisors of the patient, and canine and molar regions on each side of the incisor region extending across the canines and molars respectively in the form of two arms extending rearward from the frontal incisor region, and the outer wall lower channel surface is set back from the outer wall upper channel surface along at least the incisor and canine regions of the outer and inner walls.

The lower portion of the outer wall may be designed to closely fit the teeth and lower arch of the patient to assist in mounting the appliance.

The outer wall lower channel surface may be set back from the outer wall upper channel surface by a distance of 0.5 mm to 2.0 mm. In particular the outer wall lower channel surface may be set back relative to the outer wall upper channel surface by a distance of 1.0 mm to 1.5 mm.

The outer wall upper channel surface may extend upward away from the upper web surface at an angle of 80 degrees to 100 degrees. In particular the outer wall upper channel surface may extend upward away from the upper web surface at an angle of 85 to 90 degrees.

The outer wall includes a buccal outer surface facing away from the channels, and the upper portion of the buccal outer surface of the outer wall may be substantially vertically extending when fitted on the patient, and the lower portion of buccal outer surface may extend at an angle of 2 to 10 degrees to a line passing through the upper portion of the buccal outer surface.

The outer wall upper channel surface may extend to a height of 11 to 15 mm above the upper web surface along substantially a full length of the appliance.

The inner wall may have an upper portion above the web and a lower portion below the web and the upper portion may define an inner wall upper channel surface and the lower portion below the web may define an inner wall lower channel surface.

The inner wall upper channel surface may be arranged and positioned so that it bears up against the teeth and upper arch of the patient.

The lower portion of the inner wall may have a terminal edge region, and an upper surface of the terminal edge region forms the tongue elevator.

A part of the terminal edge region of the inner wall may be enlarged and the enlarged part may form the tongue elevator.

The tongue elevator formed by the upper surface of the terminal edge region may be at a vertical distance of 2 mm to 6 mm beneath the lower web surface. In particular the tongue elevator may be a vertical distance of 3 mm to 5 mm beneath the lower web surface.

The outer and inner walls may be resiliently flexible which enables the appliance to be fitted to a patient having upper and lower arches that do not match the upper and lower channels of the appliance by deforming the outer and inner walls to receive the patient's upper and lower arches in the upper and lower channels.

The upper and lower channels may be formed with a predetermined arch form so that when the appliance is applied to a patient having an underdeveloped upper arch, the outer and inner walls and the web are resiliently flexed out of their original resting position and as a result a return force is applied to the upper arch of the patient for promoting expansion of the upper arch.

The orthodontic appliance may comprise: a teeth contacting member forming the outer wall, the inner wall and the web, the teeth contacting member being formed of a cushioning material for cushioning the appliance against the teeth and gums of the patient; and a base member encased within the teeth contacting member for conferring a suitable level of structural stiffness on the appliance while still permitting some resilient flexing thereof.

The base member may comprise a frame structure that is resiliently flexible, the frame structure including a frame web portion that is broadly coextensive with the web, and a frame wall portion projecting substantially orthogonally up from the frame web portion for conferring sufficient stiffness on the outer wall to hold the buccal mucosa away from the upper arch while the appliance is being worn.

The frame wall portion may comprise an upper wall frame section above the frame web portion and a lower wall frame section below the frame web portion, and the lower wall frame section may be set back from the upper wall frame section, i.e. offset from the upper frame wall section.

The lower wall frame section may be set back from the upper wall frame section by a distance of 0.5 mm to 2.00 mm.

The frame wall portion is broadly coextensive with the outer wall.

According to another aspect there is provided an orthodontic appliance for treating a class 3 malocclusion in a patient having an upper and a lower arch, the appliance comprising:

an outer wall and an inner wall, and a web extending between the inner and the outer walls forming a lower web surface and an upper web surface, the outer wall, inner wall and web define an upper channel within which the upper arch can be received and a lower channel within which the lower arch can be received, the outer and inner walls include a frontal incisor region extending across the incisors of the patient, and canine and molar regions on each side of the incisor region extending across the canines and molars, the inner wall has an upper portion above the web and a lower portion below the web,

the outer wall has an upper portion above the web defining an outer wall upper channel surface and a lower portion below the web defining an outer wall lower channel surface, the upper web surface has a greater width between the inner and outer walls than the lower web surface, and the outer wall upper channel surface is vertically off-set from the outer wall lower channel surface with the outer wall lower channel surface set back from the outer wall upper channel surface by a distance of 0.5 mm to 2.0 mm along at least the incisor and canine regions,
wherein the upper portion of the outer wall holds the buccal mucosa spaced away from the patient's upper arch and the width of the upper web surface accommodates development of the upper arch during treatment,
the outer wall and the inner wall form a mounting arrangement for mounting the appliance on the upper and lower arches, and the lower portion of the outer wall is designed to fit closely to the teeth and lower arch of the patient; and
a tongue elevator positioned beneath the lower web surface for forcing the patient's tongue up to a height above their lower arch, the lower portion of the inner wall has a terminal edge region having an upper surface of the terminal edge region forming said tongue elevator having a vertical distance of 2 mm to 6 mm beneath the lower web surface.

According to another aspect there is provided n orthodontic appliance for treating a class 3 malocclusion in a patient having an upper and a lower arch, the appliance comprising:

a teeth contacting member including:
an outer wall and an inner wall, and a web extending between the inner and the outer walls forming a lower web surface and an upper web surface, the outer wall, inner wall and web define an upper channel within which the upper arch can be received and a lower channel within which the lower arch can be received,
   the outer wall and the inner wall form a mounting arrangement for mounting the appliance on the upper and lower arches,
   the outer wall has an upper portion above the web defining an outer wall upper channel surface and a lower portion below the web defining an outer wall lower channel surface, the upper web surface has a greater width between the inner and outer walls than the lower web surface, and the outer wall upper channel surface is vertically off-set from the outer wall lower channel surface with the outer wall lower channel surface set back from the outer wall upper channel surface along at least the incisors and canines of the patient's upper arch,
   wherein the upper portion of the outer wall holds the buccal mucosa spaced away from the patient's upper arch and the width of the upper web surface accommodates development of the upper arch during treatment; and
   a tongue elevator positioned beneath the lower web surface for forcing the patient's tongue up to a height above their lower arch,
      the teeth contacting member formed of a cushioning material for cushioning the appliance against the teeth and gums of the patient; and
      a base member comprising a frame structure that is resiliently flexible encased by the teeth contacting member for conferring a suitable level of structural stiffness on the appliance while still permitting some resilient flexing thereof,
      the frame structure including a frame web portion that is broadly coextensive with the web, and a frame wall portion projecting substantially orthogonally up from the frame web portion for conferring sufficient stiffness on the outer wall to hold the buccal mucosa away from the upper arch while the appliance is being worn, the frame wall portion comprising an upper wall frame section above the frame web portion and a lower wall frame section below the frame web portion which is offset back from the upper wall frame section,
      wherein the outer and inner walls of the appliance are resiliently flexible which enables the appliance to be fitted to a patient having upper and lower arches that do not match the upper and lower channels of the appliance by deforming the outer and inner walls to receive the patient's upper and lower arches in the upper and lower channels.

The lower wall frame section may be set back from the upper wall frame section by a distance of 0.5 mm to 2.00 mm.

According to another aspect of this disclosure there is provided a method of treating a class 3 malocclusion in a patient, the method including:
fitting an orthodontic appliance which appliance comprises,
an outer wall and an inner wall, and a web extending between the inner and the outer walls, wherein the outer wall, inner wall and web define an upper channel and a lower channel, the outer wall having a lower portion below the web defining an outer wall lower channel surface and an upper portion above the web defining an outer wall upper channel surface which is vertically offset from the outer wall lower channel surface, wherein the outer wall and the inner wall form a mounting arrangement, and the upper portion of the outer wall with the vertically offset outer wall upper channel surface forms an outer spacing formation, and
   a tongue elevator for lifting the patient's tongue to a height above their lower arch,
      wearing the appliance for several hours, and repeating wearing of the appliance in this fashion on a regular basis over a treatment period.

The fitting may include mounting the appliance on the upper and lower arches of the patient by receiving the upper and lower arches within the upper and lower channels with the patient's tongue sitting on the tongue elevator and the outer spacing formation holding the buccal mucosa away from the patient's upper arch so that it does not apply a force thereto.

Wearing the appliance may include wearing the appliance on a daily basis, e.g., including while the patient is sleeping. The treatment period may be continued for at least twelve months.

The method may include monitoring progressive correction of the malocclusion at spaced time intervals over the treatment period.

The method may include continuing treatment until the incisors on the lower arch are positioned behind the incisors on the upper arch.

The method may include wearing the appliance regularly but on a less frequent basis after initial correction of the class 3 malocclusion to maintain correct dental occlusion.

According to another aspect of this disclosure there is provided a method of treating a class 3 malocclusion in a patient, the method including:

fitting an orthodontic appliance to the upper and lower arches of a patient having a class 3 malocclusion in which the patient's upper arch incisor teeth are received behind their lower arch incisor teeth, the orthodontic appliance comprises:
an outer wall and an inner wall, and a web extending between the inner and outer walls, wherein the outer wall, inner wall and web define an upper channel and a lower channel, the outer wall having a lower portion below the web defining an outer wall lower channel surface and an upper portion above the web defining an outer wall upper channel surface which is vertically offset from the outer wall lower channel surface, and the inner wall has an upper portion above the web and a lower portion below the web, wherein the upper and lower portions of the inner wall and the lower portion of the outer wall form a mounting arrangement and the upper portion of the outer wall with the vertically offset outer wall upper channel surface forms an outer spacing formation, and
a tongue elevator for lifting the patient's tongue to a height above their lower arch, wherein the fitting includes receiving the upper arch and upper teeth within the upper channel and receiving the lower arch and lower teeth within the lower channel with the patient's tongue sitting on the tongue elevator and the outer spacing formation holding the buccal mucosa away from the patient's upper arch so that it does not apply a force thereto; and
   wearing the appliance for several hours, and repeating wearing of the appliance in this fashion on a daily basis over a treatment period of at least twelve months.

According to another aspect of this disclosure there is provided an orthodontic appliance for treating a malocclusion in a patient having an upper and a lower arch, the appliance comprising:
an outer wall and an inner wall, and a web extending between the inner and the outer walls, wherein the outer wall, inner wall and web define an upper channel within which the upper arch can be received and a lower channel within which the lower arch can be received, wherein the outer wall has a lower portion below the web defining an outer wall lower channel surface and an upper portion above the web defining an outer wall upper channel surface that is vertically offset from the outer wall lower channel surface, wherein the outer wall and the inner wall form a mounting arrangement for mounting the appliance on the upper and lower arches of the patient, and the upper portion of the outer wall having the vertically offset outer wall upper channel surface forms an outer spacing formation for holding the buccal mucosa spaced away from the patient's upper arch in use; and
   a tongue elevator for lifting the patient's tongue to a height above their lower arch.

The outer spacing formation may extend across the incisor region, the canine region, and the molar region of the patient's upper arch.

The outer wall lower channel surface may be set back relative to the outer wall upper channel surface by a distance of 0.5 mm to 2.0 mm. For example the outer wall lower channel surface may be set back relative to the outer wall upper channel surface by a distance of 1.0 mm to 1.5 mm.

The outer wall may have a buccal outer surface facing away from the channels. The inner wall may have an upper portion above the web defining an inner wall upper channel surface and a lower portion below the web defining an inner wall lower channel surface. The inner wall may also have a lingual inner surface facing away from the channels. The web may include an upper channel web surface and a lower channel web surface.

The upper channel web surface may have a greater width between the inner and outer walls than the lower channel web surface. The upper channel web surface and the outer wall upper channel surface may be dimensioned so as to permit development of the upper arch of a user and consequent displacement of the teeth of the upper arch relative to the lower arch.

The outer wall upper channel surface may extend upward away from the upper channel web surface at an angle of 80 degrees to 100 degrees. The outer wall upper channel surface may extend upward away from the upper channel web surface at an angle of 85 to 90 degrees.

Each of the outer and inner walls may include a frontal incisor region extending across the incisors of the patient, and canine and molar regions on each side of the incisor region extending across the canines and molars of the patient, the canine and molar regions being in the form of two arms extending rearward from the frontal incisor region such that the overall configuration corresponds to the arch of a patient.

The outer wall upper channel surface may extend up to a height of at least 10 mm above the upper channel web surface along the incisor region thereof. For example the outer wall upper channel surface may extend to a height of 11 to 15 mm above the upper channel web surface. By this it is meant that the outer wall upper channel surface extends up to this height along at least part of its length but not necessarily along its full length.

The upper portion of the outer wall including the outer wall upper channel surface and the upper portion of the buccal surface of the outer wall may be substantially vertically extending. Further the upper portion of the outer wall may extend substantially vertically up from the upper channel web surface, and the outer wall may be curved in a longitudinal direction to complement the overall curved configuration of the arch.

The outer and inner walls forming the mounting arrangement may be resiliently flexible. The lower portion of the outer wall may be designed to fit closely to the teeth and lower arch of the patient to assist in mounting the appliance on the patient. The inner wall upper channel surface may be arranged and positioned so that it bears up against the teeth and upper arch of the patient.

The resilient flexibility of the outer and inner walls forming the mounting arrangement enables the appliance to be fitted to a patient having upper and lower arches that do not match the upper and lower channels of the appliance by deforming the outer and inner walls in a way that enables their upper and lower arches to be received within the upper and lower channels.

The outer wall, the inner wall and the web may include a teeth contacting member which is made of a cushioning material for cushioning the appliance against the teeth and gums of the patient when the appliance is being worn.

The appliance may further include a base member that is encased within the teeth contacting member for conferring a suitable level of structural stiffness on the appliance while still permitting some resilient flexing of the mounting arrangement.

The base member may comprise an open frame structure that is resiliently flexible, the open frame structure including a frame web portion that is broadly coextensive with the web.

The open frame structure may include a frame wall portion projecting up from the frame web portion which confers sufficient stiffness on the outer wall to enable it to hold the buccal mucosa of the patient away from the upper arch. The teeth contacting member may provide sufficient cushioning of the outer wall against the intra-oral tissues of the patient to enable the appliance to be worn comfortably by the patient.

The frame wall portion may be broadly coextensive with the outer wall.

The upper and lower channels may be formed with a predetermined arch form so that when the appliance is applied to a patient having an underdeveloped upper arch, the outer and inner walls and the web are resiliently flexed out of their original resting position and apply a return force to the upper arch of the patient.

The lower portion of the inner wall may have a terminal edge region forming the tongue elevator.

The terminal edge region may be enlarged along at least part of its length and form an upper surface on which the tongue of the patient rests in use.

The upper surface of the terminal edge region forming the tongue elevator may be positioned a vertical distance of 2 mm to 6 mm beneath the lower channel web surface, e.g. a vertical distance of 3 to 5 mm below the lower channel web surface. According to another aspect of this disclosure there is provided an orthodontic appliance for being received in the mouth of a user, comprising:

a mounting arrangement for mounting over an upper arch of a user, and an outer spacing formation on the mounting arrangement for holding a portion of the buccal mucosa away from at least one of the incisor and canine regions of a user's upper arch so that the spaced portion of the buccal mucosa does not apply an inward force to this region of the upper arch.

The outer spacing formation may hold a portion of the buccal mucosa away from the incisor region of the user's upper arch. The outer spacing formation may also hold a portion of the buccal mucosa away from the molar region of the user's upper arch. Yet further the spacing formation may also hold a portion of the buccal mucosa away from the canine region of the user's upper arch. Conveniently the outer spacing formation may extend continuously across the incisors, the canines and the molars of a user.

The mounting arrangement may comprise an outer wall and an inner wall, and a web extending between the inner and the outer walls. The outer wall, the web, and the inner wall may collectively define an upper channel within which the upper arch and teeth can be received to mount the appliance to an upper arch of a user.

The outer spacing formation may be formed by the outer wall of the mounting arrangement.

The outer and inner walls of the mounting arrangement may include an incisor region extending across the incisors of a user's arch and two canine regions on each side of the incisor region for extending across the canines of a user, and two molar regions on each side, e.g. of the canine regions, for extending across the molars of a user.

The mounting arrangement including the inner and outer walls may have a generally curved form with a curved incisor region. The canine and molar regions may be in the form of two arms or arm regions extending rearward from each end of the incisor region whereby to form overall an arch shaped form. Thus the mounting arrangement may have a U shaped or parabolic form.

The mounting arrangement may be resiliently flexible. In particular the outer and inner walls and the web may be able to flex resiliently when the arms are moved or displaced out of a resting position, e.g. corresponding to a desired arch form, to accommodate a different arch width in a user, e.g. a narrow upper arch. The deformed walls and the web may apply a return force to the arch tending to return it to the resting position. The resilience of the inner and outer walls may also assist in fitting the appliance to the arch and teeth.

In addition to defining the upper channel described above, the outer wall, the web, and the inner wall may also define a lower channel within which the lower arch teeth can be received. The inner and outer walls may each have upper and lower terminal edges, and the web may be positioned intermediate the upper and lower terminal edges of the inner and outer walls whereby to define the upper and lower channels. The mounting arrangement may have a generally H shaped cross section along its length.

The outer wall defined above, may comprise an upper outer wall portion that is above the web, and a lower outer wall portion that is below the web. Similarly the inner wall may have an upper inner wall portion that is above the web and a lower inner wall lower portion that is below the web.

The outer and inner walls may define the following surfaces. The outer wall may have a buccal outer surface, an outer wall upper channel surface and an outer wall lower channel surface. The inner wall may have a lingual inner surface, an inner wall upper channel surface and an inner wall lower channel surface. The web may include an upper channel web surface and a lower channel web surface.

The upper channel may be defined by the outer wall upper channel surface, the upper channel web surface and the inner wall upper channel surface. In use the teeth and gums of the upper arch of a user make contact with one or more of these surfaces to mount the mounting arrangement thereto. Correspondingly the lower channel may be defined by the outer wall lower channel surface, the lower channel web surface and the inner wall lower channel surface described above, that similarly make contact with the teeth and gum tissues of the lower arch, e.g. to fit the mounting formation on the arch/es. Further the mounting arrangement assists in the correct positioning of a user's lower arch relative to their upper arch by having upper and lower channels for receiving respectively the teeth of the upper and lower arches.

The outer wall upper channel surface may be vertically offset relative to the outer wall lower channel surface. Specifically the lower channel surface may be set back relative to the upper channel surface by a distance of 0.5 mm-2.0 mm, e.g. 1.0 mm to 1.5 mm. In addition, the inner wall upper channel surface may be vertically off-set relative to the inner wall lower channel surface.

The upper channel web surface may be substantially planar, e.g. flat and planar, for end surfaces of a user's teeth to bear against. The upper channel web surface may have some curvature as the web surface leads into the outer wall and inner wall upper channel surfaces respectively. The outer wall upper channel surface may extend upward away from the web surface broadly in a straight line.

The outer wall upper channel surface may have a substantially upright orientation (as distinct from a sloping orientation) and may extend upwardly away from the upper channel web surface at an angle of 80 degrees to 100 degrees to the upper channel web surface, e.g. at 85 degrees to 90 degrees.

The buccal surface of the upper portion of the outer wall may also extend upwardly away from the upper channel web surface at an angle of 80 degrees to 100 degrees to the upper channel web surface, e.g. at 85 degrees to 90 degrees.

In one form the upper portion of the outer wall, including the outer wall channel surface and the upper portion of the buccal surface of the outer wall, may be substantially vertically extending.

The outer wall upper channel surface may extend up to a height of at least 8 mm, e.g. at least 10 mm, above the upper channel web surface along the incisor region thereof. In some forms the outer wall upper channel surface may extend up to a height of 11 to 15 mm above the upper channel web surface. The outer wall upper channel surface may extend up to a minimum height (or lowest height) along its length of at least 8 mm above the upper channel web surface.

The upper channel web surface and the outer wall upper channel surface may be suitably dimensioned to permit development of the upper arch of a user and consequent displacement of the teeth of the upper arch relative to the lower arch over time. The upper channel web surface may have a greater width between the outer and inner walls than the lower channel web surface.

The outer wall upper channel surface may have a step formation defined therein intermediate the web upper channel surface and the terminal edge of the outer wall.

The step formation may step outward so that the wall is thicker below the step formation, and the step formation may extend substantially the full length of the outer wall parallel to the upper channel web surface. The purpose of the step is to increase the space between the upper arch and associated gum tissues and the outer wall thereby encouraging development of the midfacial region.

Apart from the step formation, the upper portion of the outer wall may have a substantially even cross sectional thickness in the direction of its height and also along its length.

The inner wall upper channel surface is arranged and positioned so that it bears up against the teeth and associated gum tissues of the upper arch of a user, e.g. with a fit that makes contact with the teeth and associated gums of a user. In particular the inner wall upper channel surface may be sized to fit snugly against the teeth and associated gum tissues along the full arch length. This may assist with fitting the mounting formation to the arch and teeth.

The inner wall upper channel surface may curve upward and away from the upper channel web surface in a direction away from the upper channel web surface, e.g. towards the interior of the U shaped form of the inner wall. The curvature of the inner wall upper channel surface may be quite pronounced. Further the width or extent of the inner wall upper channel surface may deplete in a direction towards the rear of the U shaped wall. The inner wall upper channel surface may be short and substantially upright towards its rear ends.

The lower web surface, like the upper web surface, may be substantially planar for end surfaces of a user's teeth to bear against it. Overall the web may be of broadly similar cross sectional thickness across its width and along its length.

The outer wall lower channel surface may extend downwardly at an angle of 80 degrees to 90 degrees to the lower web surface, e.g. at 85 to 89 degrees to the lower web surface. The outer wall lower channel surface may also extend downwardly at an angle of 80 degrees to 90 degrees to the upper web surface,

The vertical extent of the lower portion of the outer wall may be significantly less than that of the upper portion of the outer wall. For example the vertical extent or vertical height of the outer wall lower channel surface may be 2 to 8 mm, from the lower channel web surface to the terminal lower edge of the outer wall.

The outer wall lower channel surface is designed to fit closely to the teeth and lower arch of a user and is not dimensioned to be spaced from the buccal surface of the teeth, like the upper portion of the outer wall.

The lower channel surface of the outer wall, and the lower portion of the buccal surface of the outer wall may be substantially linear, when extending in a direction from the lower web surface to the terminal lower edge of the outer wall. The lower portion of the buccal surface of the outer wall may be inclined relative to the upper portion of the buccal surface of the outer wall, e.g. at an angle of 2 to 10 degrees.

The orthodontic appliance may further include a tongue elevating formation on the mounting arrangement for elevating the tongue of a user to a position where it does not apply pressure to the lower arch of the user. The tongue elevating formation may be formed on the inner wall.

The inner wall lower channel surface may curve outwardly away from the lower channel web surface in a direction extending away therefrom, e.g. towards the interior of the U shaped form. The lower portion of the lingual surface of the inner wall may also curve downwardly in a similar fashion.

The lower portion of the inner wall may include a a terminal edge region extending along the terminal lower edge thereof. The tongue elevating formation may be positioned on the terminal edge region.

The tongue elevating formation may be formed by having the terminal edge region of increased thickness along at least part of its length. In particular the terminal edge region may be a bulbous terminal edge region extending along at least the intermediate region of the inner wall. The bulbous terminal edge region may have a diameter of 3-6 mm.

The bulbous terminal edge region may extend along the incisor region and may also extend along at least part of the canine and/or molar regions of the inner wall. In one form the bulbous terminal edge region may extend along at least half of the length of the inner wall.

The bulbous terminal edge region may encourage a user's tongue to adopt a position resting on the bulbous terminal edge region, e.g. an upper surface thereof so that it does not exert a significant developmental pressure on the lower arch. The tongue elevating formation may have an uppermost point, and the uppermost point of the elevating formation may be positioned 2 mm to 6 mm beneath the lower channel web surface, e.g. 3 mm to 5 mm below the lower channel web surface.

The outer wall may have a cut away in the incisor region thereof for permitting the molar regions of the inner and outer walls to be moved towards and away from each other to accommodate different arch sizes in different users. The cutaway may be located in the upper portion of the outer wall, and conveniently the cutaway may be broadly centrally positioned.

Similarly the inner wall may have at least one cutaway defined broadly in the incisor region for facilitating the arms of the inner wall being moved towards and away from each other to accommodate varying arch widths. The inner wall may have a cutaway defined in each of the upper and lower portions thereof.

The inner wall may further have a tongue tab formed in the upper portion thereof. The tongue tab indicates a correct tongue position to a user when the tip of their tongue bears against the tongue tab. The tongue tab typically is located in a front central position on the inner wall and may be formed integrally with the inner wall as a part thereof. The tongue tab is quite different to the tongue elevating formation in that it does not actively direct a user's tongue to adopt a correct position. It simply provides a locator for the tongue tip that helps a user to voluntarily position their tongue correctly.

Conveniently the inner wall may have two said cutaways on the upper portion thereof, one on either side of the tongue tab.

The upper portion of the outer wall may include two further recess cutaways on respectively the left and right arms of the mounting arrangement, e.g. in the molar region thereof. These further recess cutaways contour around a bony protrusion at this point along the upper arch and thereby permit the protrusion to project there through. This feature therefore increases user comfort when the appliance is worn.

The mounting arrangement may have apertures defined therein. In particular the mounting arrangement may have two laterally spaced apertures passing through the outer wall, the web, and the inner wall, in the incisor region thereof.

The mounting arrangement may form a teeth contacting member that interacts with a user's mouth and also has external structural features such as the outer wall, the inner wall, the web, the tongue elevating formation and the tongue tab integrally formed therewith.

The appliance further includes an internal structure in the form of a base member that is received internally, e.g. encased, within the teeth contacting member.

The base member may be made of a stiffer material than the teeth contacting member for conferring some stiffness and structural rigidity to the mounting arrangement while still providing it with an ability to resiliently flex to enable it to be deformed out of a resting position to accommodate different users.

The base member may comprise a framed structure, e.g. an open framed structure, to assist in conferring the requisite stiffness and structural rigidity while still providing said resilience. The open framed structure may comprise a framed web portion broadly coextensive with the web of the mounting arrangement and a framed wall portion that is broadly coextensive with the outer wall. The framed wall portion may comprise an upper framed wall portion on one side of the web portion extending across the upper portion of the outer wall, and a lower framed wall portion extending across the lower portion of the outer wall.

Each said framed portion may comprise two longitudinal frame members and a plurality of cross members extending between the two longitudinal members at spaced intervals along their length. One of the longitudinal members of the upper framed wall portion may be joined to one of the longitudinal members of the lower framed wall portion, and one of the longitudinal members of the framed web portion may be joined to a longitudinal member of the upper framed wall portion.

The lower framed wall portion may be vertically offset with respect to the upper framed wall portion. In particular the lower framed wall portion may be set back relative to the upper framed wall portion by a distance on 0.5 to 2.0 mm, e.g. 1.0 mm to 1.5 mm. This corresponds broadly to the similar offset between the outer wall upper channel surface and the outer wall lower channel surface.

As described above the frame structure of the base member may be made of a material that is selected to provide sufficient stiffness and rigidity while still permitting some resilient deformation and resilient flexing of the member to accommodate different arch widths in different users. The material of the framed structure of the base member may be selected from the group consisting of polyamide, polyethylene, polypropylene, polyurethane, polycarbonate or santoprene. Conveniently the framed structure may be made from a polyamide material, e.g. formed by condensation polymerization of amide monomers or a ring opening polymerization of caprolactam. In particular the polyamide polymer may be a material sold under the trade mark of NYLON™. The combination of stiffness and rigidity on the one hand and resilience on the other hand has been found unexpectedly to be particularly useful. While capable of flexing when subjected to a bending force this polyamide material has a good memory and tends to return its original resting position or its original form. The framed structure may be formed as an integral article made of a homogeneous material in a moulding operation, e.g. an injection moulding operation.

The teeth contacting member may be made of a cushioning material for enabling the mounting arrangement to be comfortably fitted against the gums of a user. The teeth contacting member may be made of a polymeric material containing silicon as a repeating monomer unit within the polymer, e.g. a siloxane polymer or a silane polymer, forming a synthetic elastomer which is a cross linked polymer reinforced with silica, yielding a soft silicon rubber material. Conveniently medical grade silicon rubber may be used because it is already widely used in medical applications and has been approved for use in relation to humans. Silicon rubber has some ability to deform like a cushion and is therefore soft and comfortable against the gums and teeth of a user. Instead the teeth contacting member may be made of an addition polymer such as PVC (polyvinylchloride). This material is available in different grades and a soft grade can be chosen for this application. The teeth contacting member may be moulded as an integral article, around said base member, in a second injection moulding operation. The inner and the outer wall, the web, and the tongue elevating formation and the tongue tab may be integrally moulded with the teeth contacting member.

According to another aspect of this disclosure there is provided an orthodontic appliance for being received in the mouth of a user, comprising:

a mounting arrangement for mounting over an upper arch of a user, and a tongue elevator mounted on the mounting arrangement for elevating the tongue of a user to a position where it does not apply significant developmental pressure to the lower arch of a user.

The mounting arrangement may comprise an outer wall, and an inner wall, and a web extending between the inner and the outer walls. The outer wall, the web, and the inner wall, may collectively define an upper channel within which the upper arch teeth can be received, and a lower channel within which the lower arch teeth can be received. The tongue elevating formation may be formed on the inner wall.

The appliance may further include an outer spacing formation on the mounting arrangement, and the outer spacing formation may be formed by the outer wall of the mounting arrangement, e.g. an upper portion thereof defining the upper channel.

According to another aspect of this disclosure there is provided an orthodontic appliance for being received in the mouth of a user, comprising:

a mounting arrangement for mounting over an upper arch of a user having an arch shape, the mounting arrangement being formed from a resiliently flexible material so that the mounting arrangement is operatively able to adapt to the arch shape and associated teeth of the user; and

an outer spacing formation on the mounting arrangement for holding a portion of the buccal mucosa spaced away from at least part of a user's upper arch so that the buccal mucosa does not apply an inward force to this region of the upper arch.

The mounting arrangement may be formed with an arch form corresponding to correct dental occlusion so that when the appliance is applied to a user having an underdeveloped upper arch, the mounting arrangement is resiliently flexed out of its original position and as a result will apply a return force to the teeth and arch tissues of the upper arch of a user that will tend to expand the upper arch of a user.

The mounting arrangement may comprise an outer wall and an inner wall, and a web extending between the inner and the outer walls defining an upper channel for the arch having a form corresponding to correct dental occlusion in its original position. The outer spacing formation may be formed by the outer wall of the mounting arrangement and may extend continuously over the incisors, canines and molars of a user's upper arch in use.

The mounting arrangement may have a curved incisor region with trailing arm regions extending rearward from each side of the incisor region.

The trailing arm regions may be resiliently flexed out of their resting position, and the mounting arrangement will apply a return force tending to return the arm regions to the original position when this occurs.

The arm regions of the channel may be moved towards each other to accommodate a narrowed upper arch width, and in response thereto the mounting arrangement will apply a return force in an outward direction tending to expand the upper arch to a position corresponding to the original position of the mounting arrangement.

The distortion of the web part of the mounting arrangement may generate a significant proportion of the return force when the mounting arrangement is deformed out of its original position by virtue of the fact that its major surfaces are deformed by the movement of the arm regions towards and away from each other. The reduced profile of the web in the forwardmost incisor region assists in enabling the arm regions to be moved towards and away each other. In a fortuitous coincidence the incisor teeth have a thinner end profile than the molar teeth thereby facilitating this reduced profile of the web in the incisor region.

The upper and lower channels may have sufficient dimensional tolerance to be fitted to a range of users with different teeth sizes.

The appliance may comprise a teeth contacting member defining said mounting arrangement and said outer spacing formation, and a base member encased within the mounting arrangement.

The teeth contacting member may be formed of a resiliently flexible material that is also soft for forming a cushion for bearing against the teeth and gums of a user, e.g. that has some ability to conform to the contours of the surface of arch and teeth tissues against which it bears.

The base member may be made of a material having resilient flexibility that is stiffer than the material of the mounting arrangement.

The appliance may include a tongue elevating formation mounted on the inner wall. The tongue elevating formation may be integrally formed with the inner wall and thereby the rest of the mounting arrangement by moulding, e.g. injection moulding.

According to yet another aspect of this disclosure there is provided an orthodontic appliance, comprising:

a mounting arrangement for mounting over an upper arch of a user including an outer wall and an inner wall, and a web extending between the outer wall and the inner wall, wherein the outer wall, the web, and the inner wall collectively define an upper channel within which the upper arch and associated teeth of a user can be received whereby to mount the mounting arrangement to the upper arch, and a lower channel for receiving the lower arch and associated teeth of a user, wherein the outer wall has an upper portion that is configured to form an outer spacing formation for holding the buccal mucosa spaced away from the gums and teeth of the upper arch.

The mounting arrangement may have an incisor region and two arms extending back from the incisor region that extend across the canines and molars of the upper arch of a user, and the mounting arrangement may be resiliently flexible to enable the arms to be moved towards and away from each other to some extent to accommodate different arch sizes. The resiliently flexible mounting arrangement also helps the mounting arrangement to be fitted onto the arch and teeth of a user.

The appliance may include a tongue elevating formation below the web for interfering with the tongue of a user and forcing the tongue to be elevated.

According to another aspect of this disclosure there is provided a method of manufacturing an appliance including:

moulding a base member from a material that when moulded has stiffness and rigidity while still permitting some resilient flexing thereof in a first moulding step;

moulding a mounting arrangement onto the base member in a second moulding step, the mounting arrangement having an integrally formed outer spacing formation for spacing part of the buccal mucosa away from the upper arch.

The method may include forming a tongue elevating formation on the mounting arrangement that is integrally moulded therewith.

The mounting arrangement may be moulded from a material that has resilient flexibility.

The base member and the mounting arrangement may each be moulded by injection moulding from a polymeric material. The technique whereby an internal base member is made of a first polymeric material in a first injection moulding operation, and then the teeth contacting member is moulded from a second polymeric material onto the base member to effectively encase the base member within the teeth contacting member is referred to as dual moulding.

The appliance may be manufactured on a commercial scale with a moulding apparatus in several standard appliance sizes that can then be fitted to the bulk of prospective user's in the population each of which has their own individual arch shape. Applicant envisages that three to five different sizes of appliance may be required to cover the overwhelming majority of prospective user's within human populations. Thus the appliance is in the nature of a manufactured appliance that is moulded in a limited number of sizes without any reference to the individual arch characteristics of the ultimate end user. The appliance is not custom built in a laboratory.

According to another aspect of this disclosure there is provided a method of treating a malocclusion of the upper and the lower arches, including:

fitting an orthodontic appliance as defined in any one of the first to fourth aspects of the disclosure above to a patient.

The method may include instructing the patient to wear the appliance on repeated occasions at spaced apart time intervals over a treatment period. The instructing may include instructing a user to wear the appliance for several hours a day, e.g. overnight while a user is sleeping. The method may include instructing a patient to wear the appliance at spaced intervals. The treatment period may be at least 12 months, e.g. at least 18 months.

The method may include selecting one size of appliance from a range of sizes in which the appliance is manufactured, the chosen size of appliance being the one that best fits the arch and teeth of the user.

The method may be used for treating a class 3 malocclusion, and the treatment period may continue until the malocclusion has been substantially corrected, e.g. the incisors on the lower arch are received behind the incisors on the upper arch.

The method may include monitoring a correction of the malocclusion at spaced intervals over the treatment period.

The method may further include maintaining correct dental occlusion in a patient after the malocclusion has been corrected. This may involve directing the patient to wear the appliance less frequently in a given time period than when active correction of the malocclusion was being carried out.

According to another aspect of the disclosure there is provided an orthodontic appliance for being received in the mouth of a user, comprising:

a mounting arrangement for mounting over an upper arch of a user, the mounting arrangement comprising an outer wall and an inner wall, and a web extending between the inner and the outer walls, so as to define collectively an upper channel and a lower channel within which the upper arch teeth and the lower arch teeth are received respectively, the outer wall defining an outer wall upper channel surface and a outer wall lower channel surface that are vertically offset relative to each other.

The outer wall lower channel surface may be set back relative to the outer wall upper channel surface by a distance of between about 0.5 mm and 2.0 mm.

The inner wall may define an inner wall upper channel surface and a lower wall channel surface and the inner wall lower channel surface may be set back relative to the inner wall upper channel surface. The distance of offset may be between about 0.5 mm and 2.0 mm.

The offset may occur along the full length of the inner wall and the offset may also occur along the full length of the outer wall.

The offset brings the teeth of the upper and lower arches into correct dental occlusion in the final stages of displacement of the teeth. If the channel surfaces are vertically aligned with each other the upper and lower teeth will be brought into edge to edge abutment. However this does not reflect correct dental occlusion and thus a device having vertically aligned channel surfaces will do not bring the upper and lower arch teeth of a patient into correct dental occlusion.

The outer wall may form an outer spacing formation as described in any one of the preceding aspects of the disclosure above and the appliance may include a tongue elevating formation formed on the inner wall as described in any one of the preceding aspects of the disclosure above.

### DETAILED DESCRIPTION

An orthodontic appliance for treating inter alia a Class 3 malocclusion in accordance with this disclosure may manifest itself in a variety of forms. It will be convenient to hereinafter describe at least one embodiment of the disclosure in detail with reference to the accompanying drawings. The purpose of providing this detailed description is to instruct persons having an interest in the subject matter of the disclosure how to carry the disclosure into practical effect. However it is to be clearly understood that the specific nature of this detailed description does not supersede the generality of the preceding broad description. In the drawings:

FIG. 1 is a schematic side view of a dental model showing correct dental occlusion;

FIG. 2 is a schematic rear view of the model of FIG. 1 showing correct dental occlusion;

FIG. 3 is a schematic side view of a dental model showing a Class 3 malocclusion with the incisor teeth of the lower arch positioned proud of the incisors of the upper arch;

FIG. 4 is a schematic rear view of a patient's teeth showing a Class 3 malocclusion with the upper arch being of narrower width than the lower arch;

FIG. 5 is a schematic three dimensional view of a Frankel appliance mounted on a dental model of a patient;

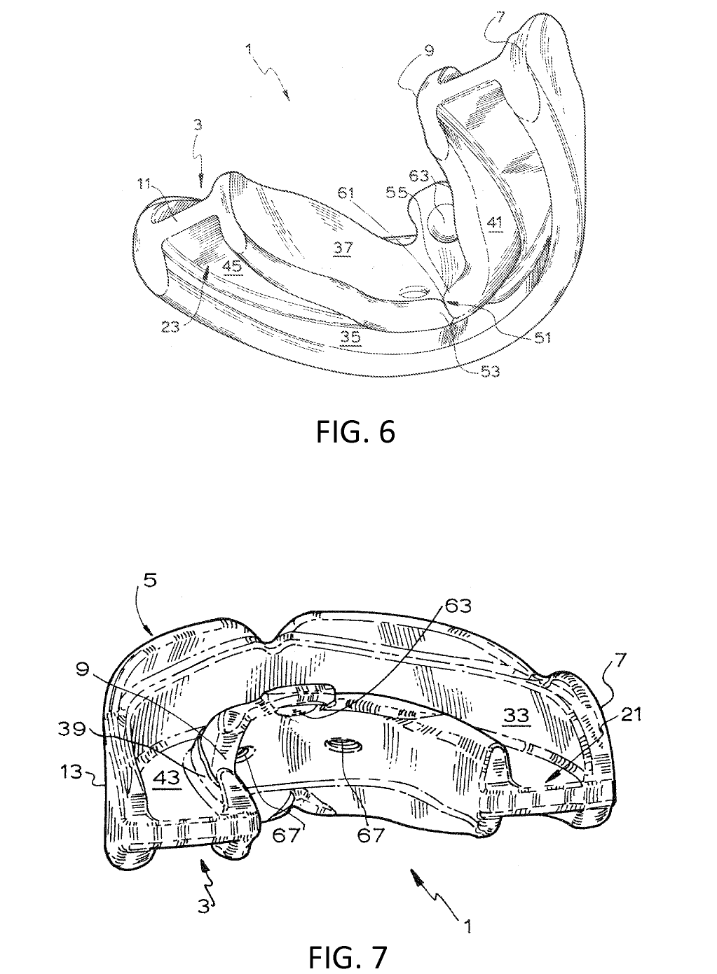

FIG. 6 is a lower three dimensional view from the rear of an orthodontic appliance in accordance with the disclosure;

FIG. 7 is an upper three dimensional view from the rear of the orthodontic appliance of FIG. 6;

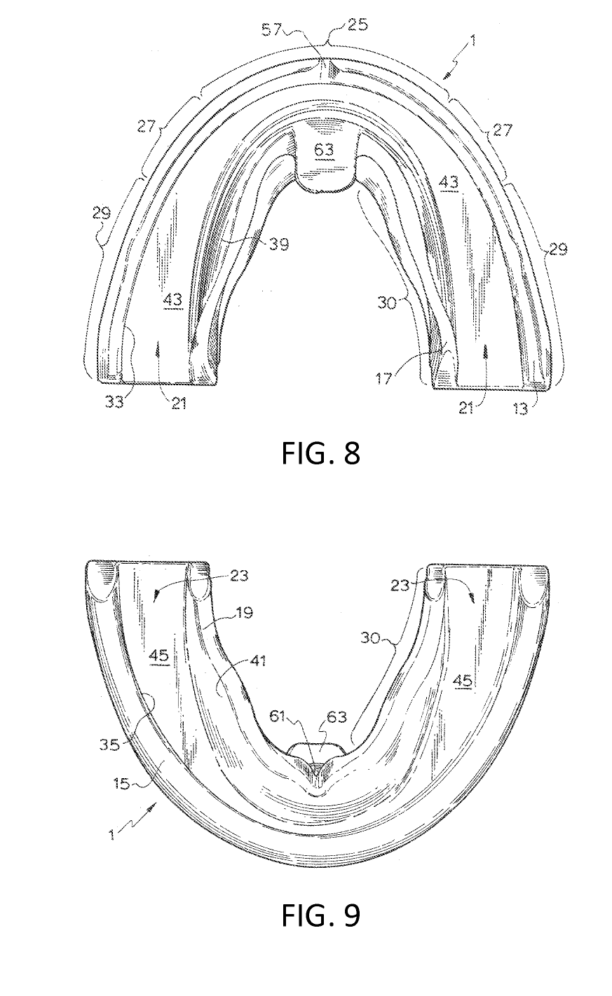

FIG. 8 is a top plan view of the appliance of FIG. 6;

FIG. 9 is a bottom plan view of the appliance of FIG. 6;

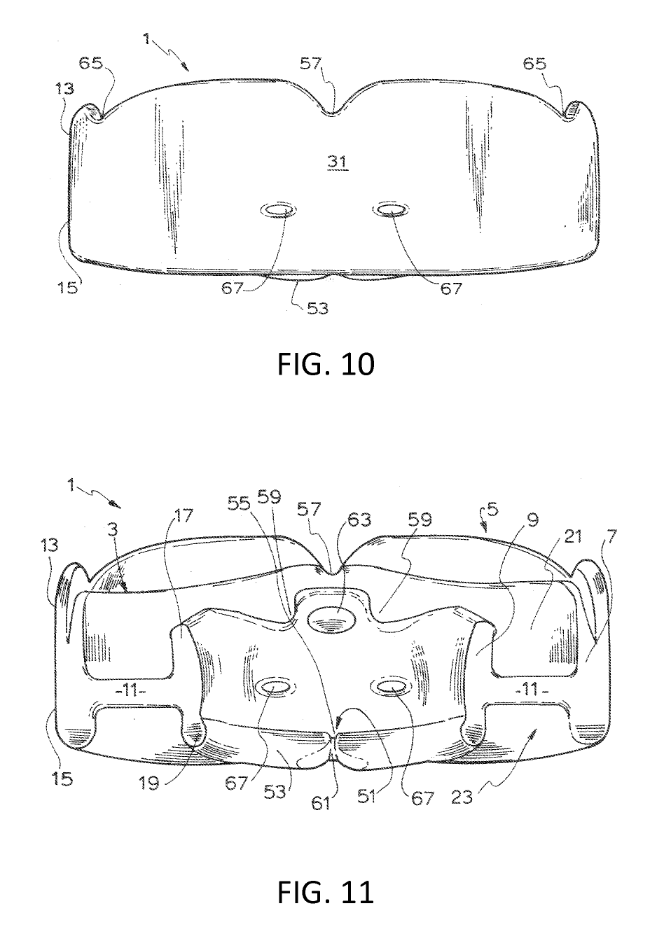

FIG. 10 is a front view of the appliance of FIG. 6;

FIG. 11 is a rear view of the appliance of FIG. 6;

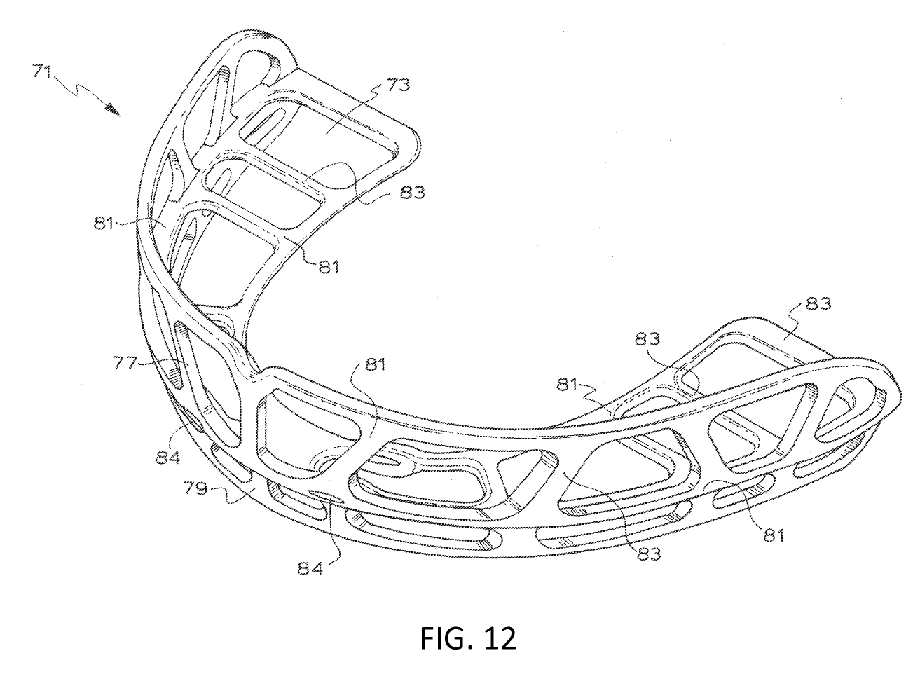

FIG. 12 is a front upper three dimensional view of an internal frame structure for the orthodontic appliance shown in FIG. 6;

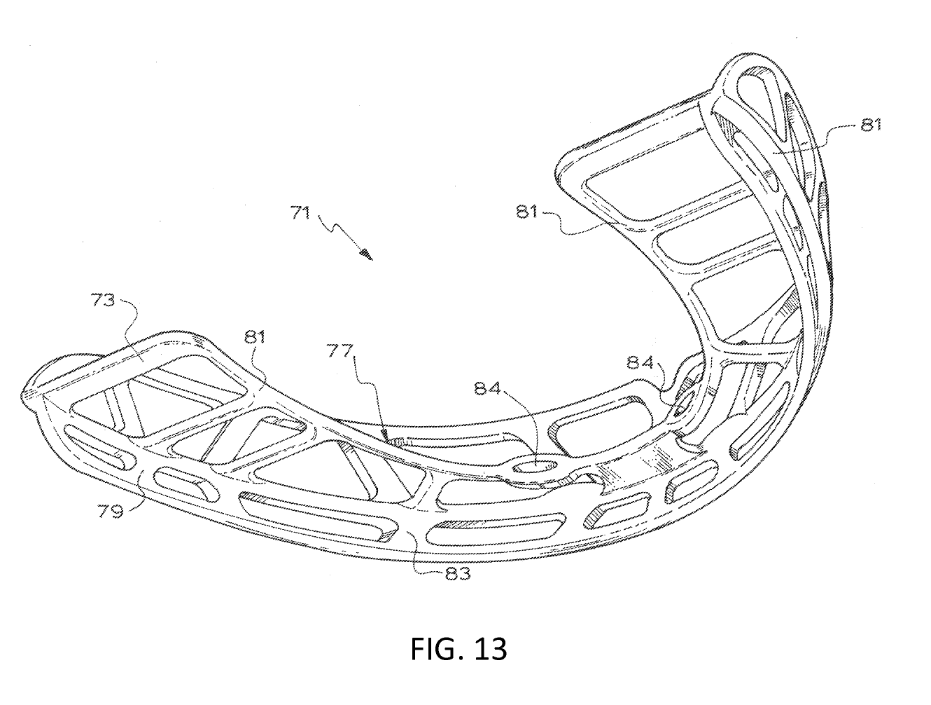

FIG. 13 is a rear lower three dimensional view of the frame structure shown in FIG. 12;

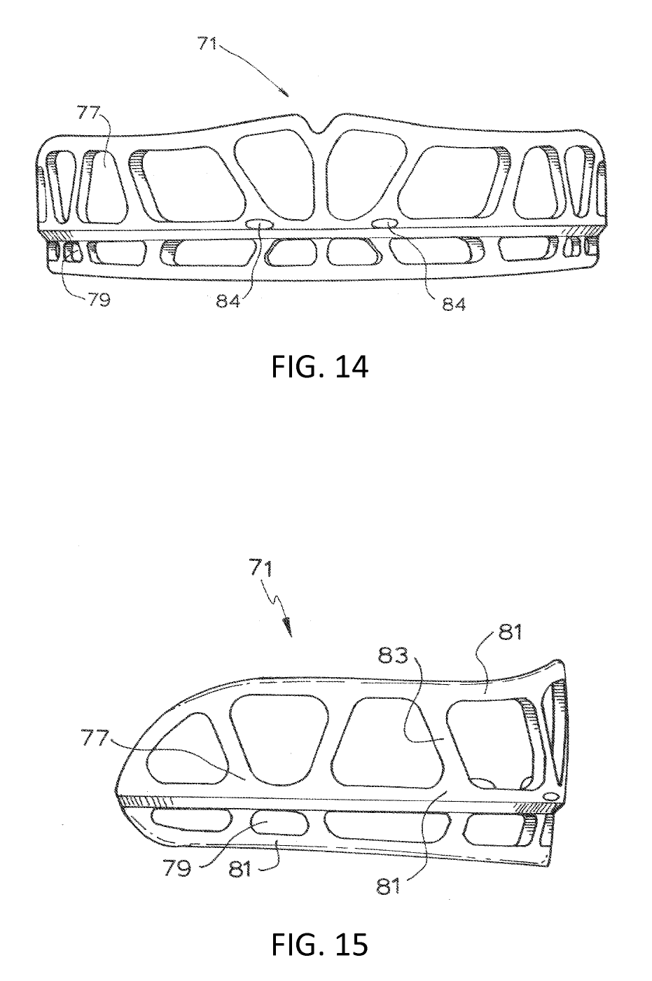

FIG. 14 is a front view of the frame structure shown in FIG. 12;

FIG. 15 is a side view of the frame structure shown in FIG. 12;

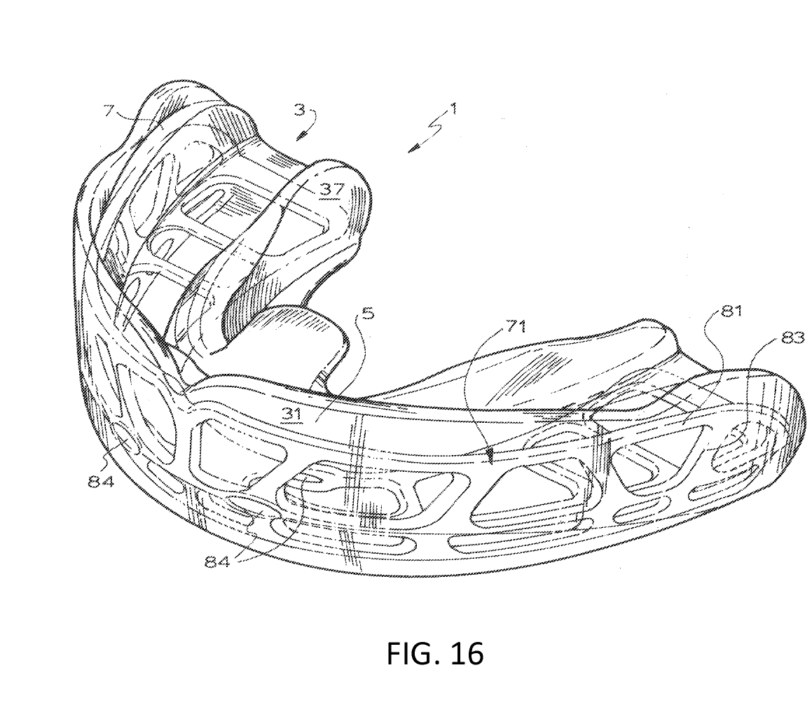

FIG. 16 is an upper three dimensional view from the front of the appliance of FIG. 6 showing the internal frame structure encased within a teeth contacting member;

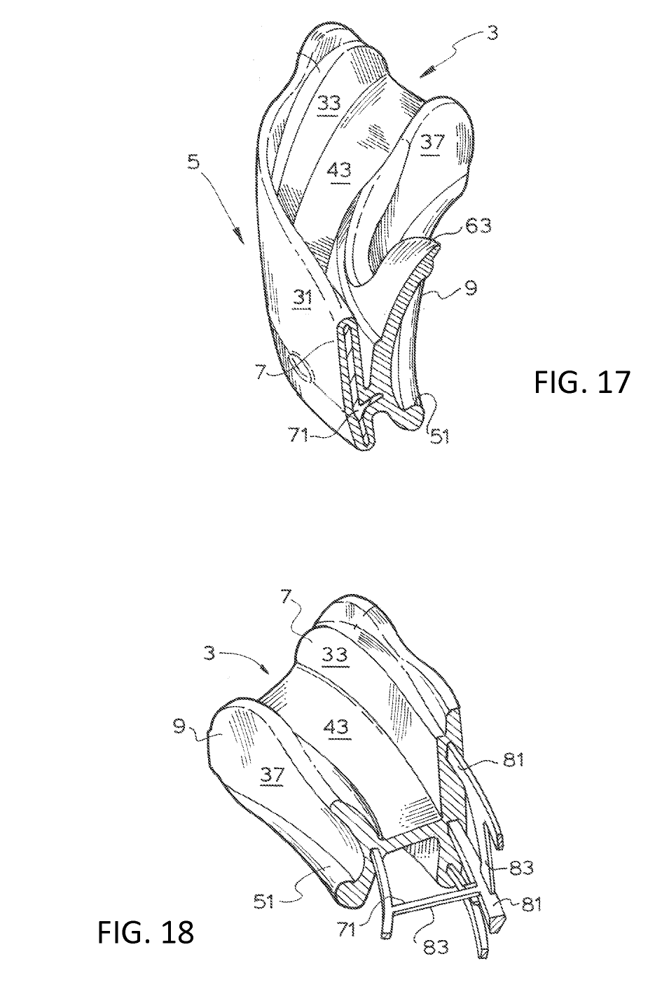

FIG. 17 is a three dimensional part sectional view of the appliance of FIG. 16 with the section taken along a midline of the appliance;

FIG. 18 is a three dimensional part sectional view of the appliance of FIG. 16 with the section taken at an intermediate position along the appliance;

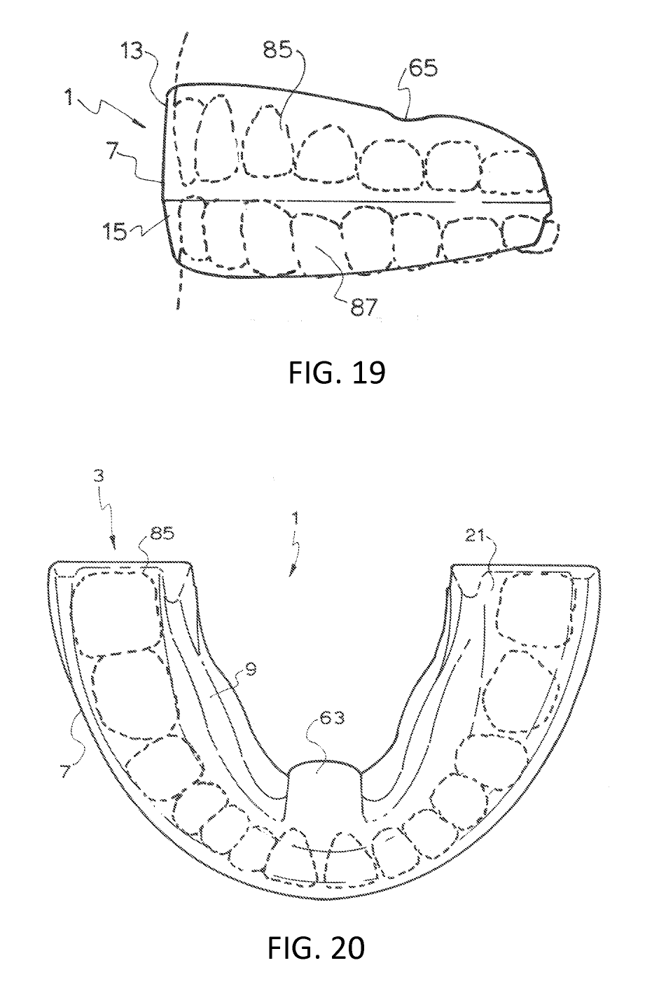

FIG. 19 is a schematic side view showing the appliance fitted onto the upper and lower arches of a user;

FIG. 20 is a plan view of the appliance fitted within the mouth of a user showing the teeth of the upper arch received within an upper channel thereof;

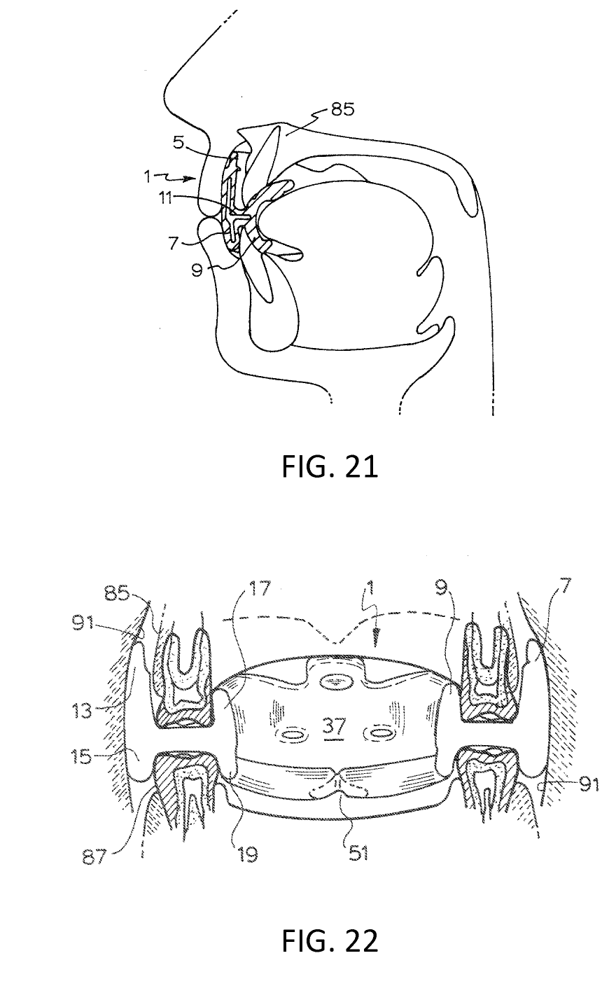

FIG. 21 is a schematic sectional side view of the appliance of FIG. 6 fitted in the mouth of a user or patient having a class 3 malocclusion, with the mouth tissues and teeth also being shown in section;

FIG. 22 is a part sectional rear view showing the appliance fitted in the mouth of the user shown in FIG. 21 having a class 3 malocclusion with the upper and lower arch and teeth being shown in section received within upper and lower channels respectively;

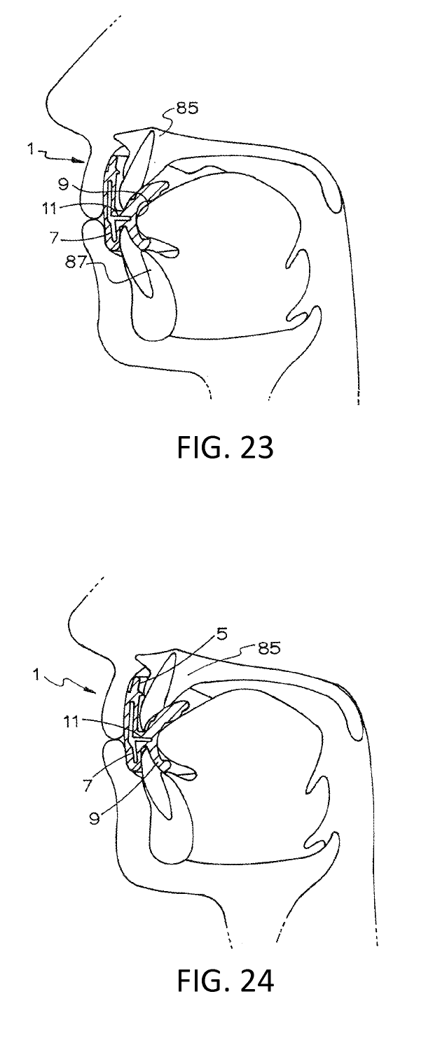

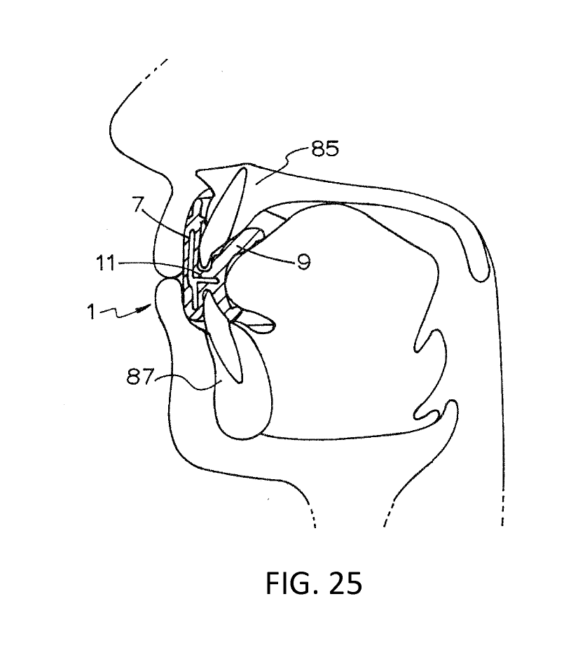

FIGS. 23 to 25 show the progressive development of the upper arch and movement of the associated upper arch teeth over the course of a treatment with the appliance of FIG. 6. FIG. 23 shows the upper arch and upper arch teeth in a first position. FIG. 24 shows the upper arch and upper arch teeth in a first position. FIG. 25 shows the upper arch and upper arch teeth in a first position;

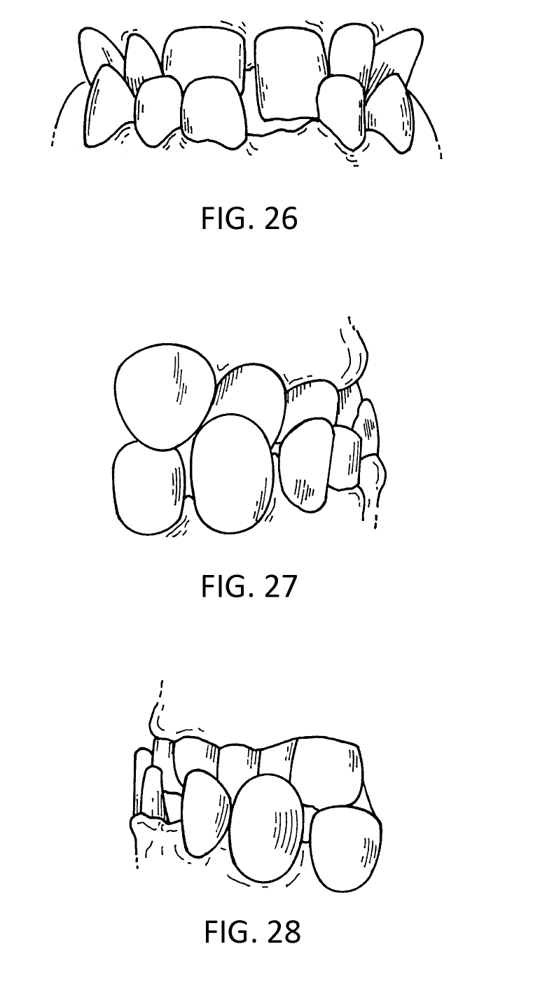

FIG. 26 is a schematic drawing of a front view of a first patient prior to the commencement of treatment;

FIG. 27 is a schematic drawing of a part side view of the patient in FIG. 26 prior to the commencement of treatment;

FIG. 28 is a schematic drawing of a side view of the patient in FIG. 26 prior to the commencement of treatment;

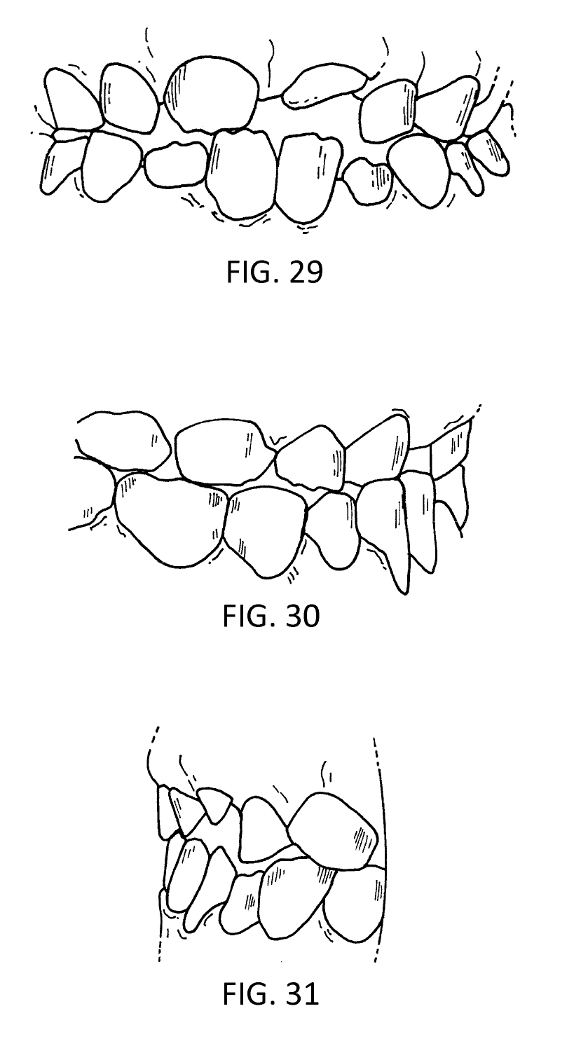

FIG. 29 is a schematic drawing of a front view of the patient in FIG. 26 after an initial treatment period;

FIG. 30 is a schematic drawing of a part side view of the patient in FIG. 26 after the initial treatment period;

FIG. 31 is a schematic drawing of a side view of the patient in FIG. 26 after the initial treatment period;

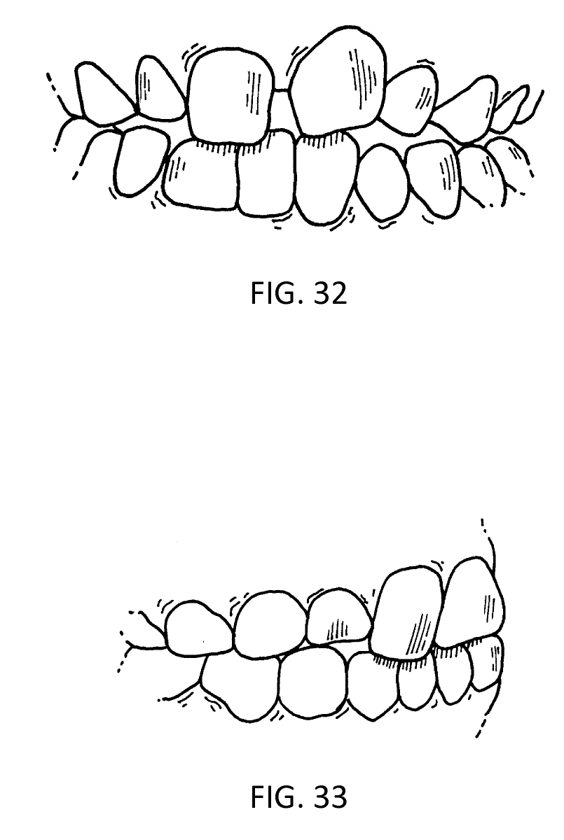

FIG. 32 is a schematic drawing of a front view of the patient in FIG. 26 after their treatment has been completed;

FIG. 33 is a schematic drawing of a part side view of the patient in FIG. 26 after their treatment has been completed;

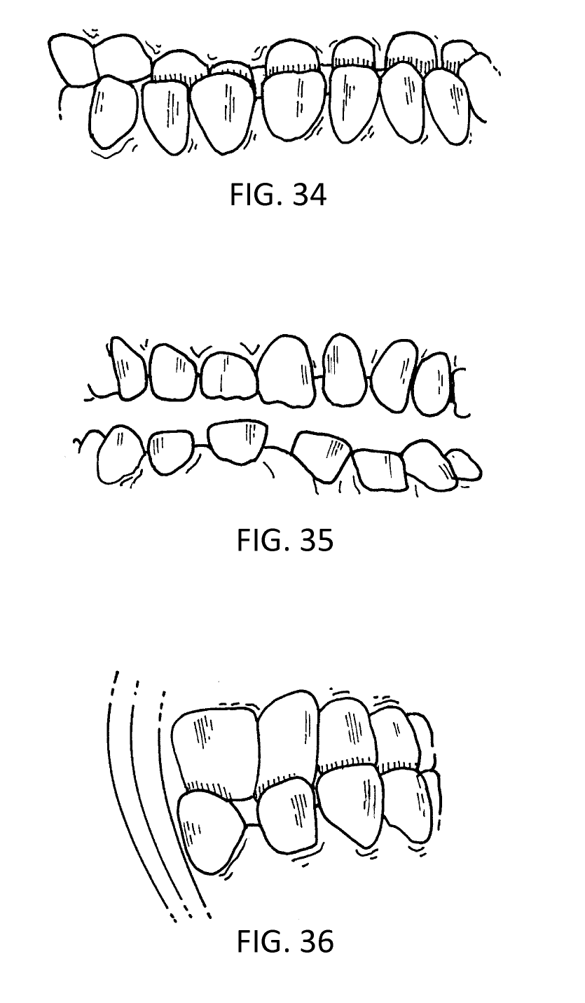

FIG. 34 is a schematic drawing of a front view of another patient prior to the commencement of treatment with their jaws closed;

FIG. 35 is a schematic drawing of a front view of the patient of FIG. 34 prior to the commencement of treatment with their jaws open;

FIG. 36 is a schematic drawing of a side view of the patient of FIG. 34 prior to the commencement of treatment with their jaws closed;

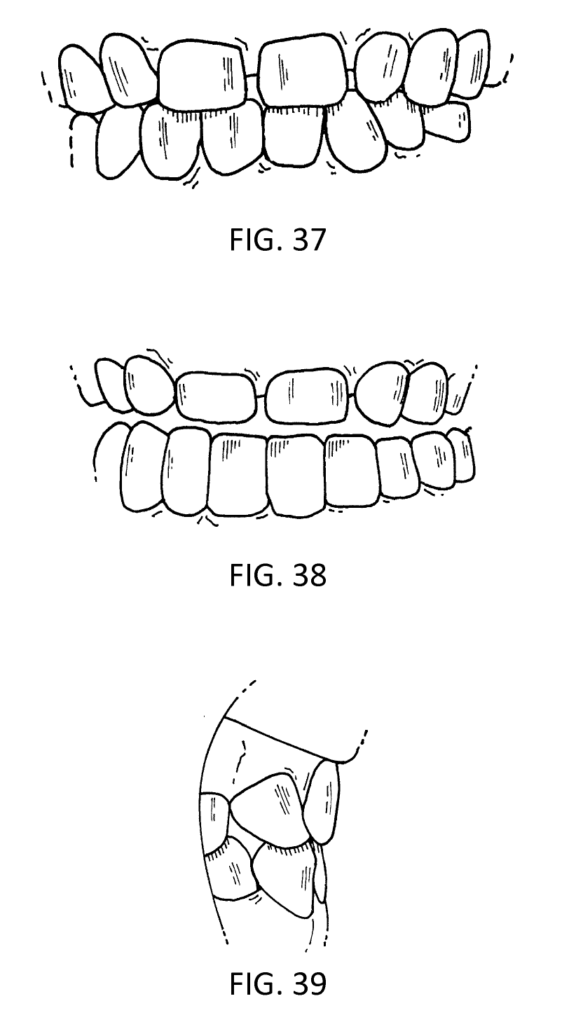

FIG. 37 is a schematic drawing of a front view of the patient of FIG. 34 at the completion of their treatment with their jaws closed;

FIG. 38 is a schematic drawing of a front view of the patient of FIG. 34 at the completion of their treatment with their jaws open; and

FIG. 39 is a schematic drawing of a side view of the patient of FIG. 34 at the end of the treatment with their jaws closed. FIGS. 1 and 2 are schematic illustrations of a dental model showing correct occlusion of the upper and lower jaws and associated teeth. FIGS. 3 and 4 are schematic drawings of a dental model illustrating a class 3 malocclusion. Correct dental occlusion and the characteristics of a class 3 malocclusion are described in some detail in the background section and will not be described further in this detailed description.

FIG. 5 is a schematic drawing of a Frankel appliance mounted on a dental model of a patient. It shows a custom made appliance that is made in a dental laboratory from bite impressions that is designed to fit only that specific user. Significantly it has no members or formations extending across the incisor or canine regions of the upper arch.

FIGS. 6 to 11 show the external shape and configuration of an appliance in accordance with the disclosure that is indicated generally by the reference numeral 1.

The appliance 1 comprises broadly a mounting arrangement shown generally by numeral 3 for mounting over an arch of a user and an outer spacing formation shown by numeral 5 for holding a portion of the buccal mucosa away from a user's upper arch so that it does not apply an inward pressure to this region and thereby inhibit development of the upper arch.

The mounting arrangement 3 comprises an outer wall 7 and an inner wall 9 and a web 11 extending between the outer and inner walls 7, 9. The web 11 is positioned intermediate upper and lower edges of the outer and inner walls 7, 9. The outer wall 7 in turn comprises an outer wall upper portion 13 above the web 11 and an outer wall lower portion 15 below the web 11. Similarly the inner wall 9 comprises an inner wall upper portion 17 above the web 11 and an inner wall lower portion 19 beneath the web 11.

The upper portion of the outer wall 13, the web 11 and the upper portion of the inner wall 17 collectively define an upper channel 21 facing upwardly for receiving the upper arch. The lower portion of the outer wall 15, the web 11 and the lower portion of the inner wall 19 define a lower channel 23 facing downwardly for receiving the lower arch of a user. The mounting arrangement 3 has a generally curved incisor region shown by numeral 25 corresponding to the incisor teeth on a user's arch, and canine regions 27 on each side thereof for extending across the canine teeth on a user's arch, The arrangement also includes molar regions 29, after the canine regions 27, for extending across at least part of the molar teeth on a user's arch. Each canine and molar region 27 and 29 on one side of the incisor region 25 may be in the form of an arm shown generally by numeral 30 extending back from the incisor region 25. Overall the mounting arrangement 2 has a parabolic arch form and having a generally H shaped cross section along its length.

The outer wall 7 has a buccal outer surface 31 facing outwardly, an outer wall upper channel surface 33 facing into the upper channel 21, and an outer wall lower channel surface 35 facing into the lower channel 23. Correspondingly the inner wall 9 has a lingual surface 37 facing away from the channels 21, 23 into the middle of the U shape. It also has an inner wall upper channel surface 39 facing into the upper channel 21 and an inner wall lower channel surface 41 facing into the lower channel 23. Further the web 11 may comprise an upper channel web surface 43 and a lower channel web surface 45.

The upper channel 21 is defined by the outer wall upper channel surface 33, the upper channel web surface 43, and the inner wall upper channel surface 39. Correspondingly the lower channel 23 may be formed by the outer wall lower channel surface 35, the lower channel web surface 45 and the inner wall lower channel surface 41. It is these surfaces defining the upper and lower channels 21, 23 that in use can make contact with the teeth and surrounding mouth tissues of a user.

As is shown particularly clearly in FIGS. 11, 17 and 22, the outer wall upper channel surface 33 is vertically offset relative to the outer wall lower channel surface 35. The outer wall lower channel surface 35 is retracted or set back relative to the outer wall upper channel surface 33 by an amount of about 1.0 mm to 1.5 mm corresponding to the relative upper and lower arch positions for correct dental occlusion as shown in FIG. 1.

There is also some offset of the inner wall upper channel surface 39 relative to the inner wall lower channel surface 41 as shown clearly in FIGS. 11, 17 and 22 once again to reflect the arch positions for correct dental occlusion.

The mounting arrangement 3 with the upper and lower channels 21, 23 is made of a resilient material that can be deformed out of its resting or original unstressed condition (corresponding to a desired arch form) and then when the deforming force is removed it returns to its original or resting unstressed position. This feature enables the appliance 1 to be fitted to different users having different arch sizes and teeth arrangements. The inner and outer walls 9, 7 around the upper and lower channels 21, 23 as well as the web 11 can be deformed to receive the teeth and arches of a user. In particular the arms 30 comprising the regions 27 and 29 of the arrangement 3 can be moved towards each other to accommodate different users with different arches. When the appliance 1 is fitted to a user with an underdeveloped upper arch the appliance 1 will typically be deformed inwardly out of its resting position (by movement of the arms towards each other) and as a result the return force applied by the resilience of the material will urge it outwardly applying an outward force to the arch and teeth of a user. This assists with mounting the appliance onto the teeth and gums of a user. It also tends to encourage growth and development of the upper arch of a user.

Thus the ability of the material to resiliently flex enables the channels 21, 23 to receive an arch in which the teeth that are not perfectly aligned and also to enable the channels to receive arches of different sizes. It also enables the channels to receive an underdeveloped arch.

The outer spacing formation 5 is formed by the upper portion of the outer wall 13 which holds the buccal mucosa of a user away from the upper arch and associated tissues of a user so that it does not apply an inward pressure to these tissues. As shown in the drawings, the outer spacing formation 5 formed by the upper portion of the outer wall 13 extends continuously along the full length of the incisors, canines and molars of a user. This resists the application of inward pressure by tissues along these regions to allow the upper arch to develop.

The web 11 may be of a similar cross sectional thickness across its width between the inner and outer walls 9, 7. Further the upper channel web surface 43 and the lower channel web surface 45 may both be substantially planar.

The outer wall 7 as a whole, and specifically the outer wall upper channel surface 33, has a substantially upright orientation and extends away from the upper channel web surface 43 at an angle of about 85 to 90 degrees, i.e. it is near perpendicular to the upper channel web surface 43. The buccal surface 31 of the outer wall upper portion 13 may be orientated at a similar angle to the outer wall upper channel surface 33, e.g. at about 85 degrees to 90 degrees to the upper channel web surface 43.

The outer wall upper channel surface 33 extends up to a height of at least 8 mm above the upper channel web surface 43 along a major portion of its length, and in some regions has a height of about 12 to 14 mm. This prominent height extends over the bone structure of the upper arch and resists the buccal mucosa from applying pressure thereto.

Further the upper channel may be dimensioned to accommodate some expansion of the upper arch during the course of treatment and progressive correction over time of a Class 3 malocclusion.

The outer wall upper channel surface 33 has an outward step formation defined therein, intermediate the web upper channel surface 43 and its terminal upper edge, that extends substantially the full length of the wall. A thicker lower portion of the outer wall is conveniently able to receive a base member in the form of an internal frame structure encased therein as will be described in more detail below.

The inner wall upper channel surface 39 is quite different in shape and character to the outer wall channel surface 33. It is positioned so that it bears up against the lingual surface of the gums and associated teeth of a user with a snug fit. The snug fit assists in mounting the appliance 1 on the arch. The snug fitting upper portion of the inner wall 17 can apply pressure to the lingual surface of the gums and associated teeth, e.g. to encourage expansion of the upper arch.

The inner wall upper channel surface 39 curves upward and away from the upper channel web surface 43 into the space between the arms 30. The lingual surface 37 of the upper portion of the inner wall 17 complements broadly the inner wall upper channel surface 39. The vertical extent of the upper portion of the inner wall 17, which extends to a height of 3 to 5 mm above the web surface 43, is considerably less than that of the upper portion of the outer wall 13.

The degree of curvature of the upper portion of the inner wall 17 is pronounced and the extent of the inner wall upper channel surface 39 depletes in a direction away from the incisor region. Each rear end of the upper portion 17 comprises a short upright wall section.

The lower inner and outer wall portions 15, 19 will now be discussed. The lower portion of the outer wall 19 may extend downwardly below the web 11 at a small angle to the upper portion of the outer wall 13. The vertical extent of the lower portion of the outer wall 19 is much less than that for the upper portion 17, e.g. depending down a distance of about 4 to 6 mm below the lower channel web surface 45.

The lower portion of the outer wall 15 is designed to fit closely to the teeth and lower arch of a user. In contrast to the upper portion 13 it is not required to form an outer spacing formation for resisting the application of pressure by the buccal mucosa to the upper arch tissues. Further it is not required to provide space for expansion of the lower arch.

Similarly the lower portion of the inner wall 19 is designed to fit closely to the teeth and lower arch of a user. The lower portion of the inner wall 19 curves away from the lower web surface into the space between the arms 30. Both the inner wall lower channel surface 41 and the lingual surface 37 of the lower portion of the inner wall 19 curve away from the web 11 in this fashion. The lower portion of the inner wall 19 depends downwardly below the web 11 a similar distance to the lower portion of the outer wall 15.

As with the upper portion of the inner wall 17 the degree of curvature is pronounced and the extent or width of the inner wall lower channel surface 41 depletes in a direction away from the incisor region 25 towards the rear of the molar regions 29. At the rear of the inner wall 9, the inner wall 9 is short and is substantially upright.

The appliance 1 also includes a tongue elevating formation (tongue elevator) 51 on the lower portion of the inner wall 19 for elevating the position adopted by a user's tongue in their mouth when the appliance is worn so that it does not apply a developmental pressure against the lower arch of a user.

The lower portion of the inner wall 19 defines a lower terminal edge and a terminal edge region 53 extending along the edge. The tongue elevator 51 is formed by having a thickened terminal edge region 53 extending along the incisor region 25 of the inner wall 9. In the illustrated embodiment the thickened terminal edge region 53 is in the form of a bulbous edge region having a diameter of 3-6 mm that is formed integrally with the inner wall 9. The elevator 51 has an uppermost point shown at 55 and the uppermost point is about 2-4 mm below the lower channel web surface. The elevator 51 forces a tip region of a user's tongue to adopt a position that is on top of the elevator as shown in the drawings where its influence on the development of the bone and tissue structures of the lower arch is reduced.

The rear ends of each arm of the mounting arrangement 3 are rounded as shown in the drawings. Specifically both the outer and inner walls 7, 9 are rounded and the walls curve respectively upwardly and downwardly away from the rear end of the web 11 which forms the rearmost point of each arm. This feature is shown most clearly in FIGS. 6 and 7.

The outer wall 7 has a cutaway 57 defined in the upper portion 17 thereof. The cutaway 57 is shown positioned centrally in the incisor region 25 and permits the arms of the appliance 1 to be moved towards and away from each other. The inner wall 9 has two cutaways 59 on its upper portion 17 and a further cutaway 61 on its lower portion 19. These cutaways 59, 61 are broadly centrally positioned and facilitate movement of the arms of the appliance 1 towards and away from each other to accommodate different arch widths.

Further a tongue tab 63 is located on the upper portion of the inner wall 9 between the two cut away formations 59. The tongue tab 63 provides a tab against which a user can locate the tip of their tongue to correctly position their tongue. It should be understood that this is in the nature of a voluntary indicator to a user of a correct tongue position. It does not force the tongue to adopt a desired position to achieve a certain orthodontic effect like the elevator 51.

The upper portion of the outer wall 13 may include two further recess cutaways 65 on the molar regions 29 thereof, e.g. on left and right arms of the mounting arrangement. These further recess cutaways 65 are configured to contour around a bony protrusion on the gum tissues of the upper arch and thereby permit the protrusion to project though the cutaway 65. This feature therefore enhances user comfort when the appliance 1 is worn by a user but does not perform any orthodontic purpose.

Further the mounting arrangement 3 has a pair of apertures 67 defined through the outer wall 7, the web 11 and the inner wall 9.

The external form and shape of the appliance 1 is determined by a teeth contacting member including the mounting arrangement 3 and outer spacing formation 5 described above. It also includes a tongue elevating formation and a tongue tab. However at a structural level the appliance 1 includes another component that is a base member 71 encased within the teeth contacting member to help provide the appliance 1 with sufficient stiffness and rigidity to return to its arch form after being resiliently flexed and also to hold the outer spacing formation 5 which is the upper portion of the outer wall 13 away from the teeth and associate tissues of the upper arch.

The base member 71 which is shown in FIGS. 12 to 18 is in the form of an open frame structure comprising a framed web portion 73 that is broadly coextensive with the web 11 and a framed wall portion that is broadly coextensive with the outer wall 7. In turn the framed wall portion may comprise an upper framed wall portion 77 coextensive with the upper portion of the outer wall 13 and a lower framed wall portion 79 coextensive with the lower portion of the outer wall 15.

Each of the upper and lower framed wall portions 77, 79 and also the web portion 73 comprises two longitudinal frame members 81 and a number of cross members 83 extending between the longitudinal frame members 81 along their length. Further as shown in the drawings one longitudinal frame member 81 of the upper framed wall portion 77 is joined to one longitudinal frame member 81 of the lower framed wall portion 79. Yet further one longitudinal frame member 81 of the framed web portion 73 is joined to the joined frame members 81 of the upper and lower framed wall portions 77, 79. Further the lower framed wall portion 79 is offset, in an inward direction, from the upper framed wall portion 77, by an offset distance of about 1.0 mm to 1.5 mm. This offset mimics the offset of the upper portion of the outer wall 13 to the lower portion of the outer wall 15 and particularly to the outer wall channel surfaces 33, 35 thereof.

The framed structure 71 also includes passages 84 there through from the lingual to buccal surfaces thereof corresponding to those on the mounting arrangement 3. The passages 81, 67 in respectively the framed structure 71 and the mounting arrangement 3 coincide.

The framed structure 71 is made from a material that provides a suitable amount of stiffness and thereby structural strength while still being able to flex resiliently. The framed web portion 73 in particular is able to adjust to different arch forms and arch widths while applying a return force when it is moved out of its resting position tending to return it to its original position. The framed wall portion 75 is also required to have sufficient inherent strength to hold the soft tissues of the cheek and buccal mucosa away from the upper arch tissues of a user so that it does not apply a force to the maxilla bone of the upper arch.

The framed structure 71 is made of a resilient polymeric material that is capable of being moulded that is selected from the group consisting of polyamide, polyethylene, polypropylene, polyurethane, polycarbonate, or santoprene. In the illustrated embodiment the framed structure 71 is formed from a polyamide material sold under the trade mark NYLON™. This material has been found to have a suitable level of stiffness and rigidity while permitting resilient flexing out of its resting position. Further this material has a good memory and retains its ability to return to its original form when the flexing force is removed.

The teeth contacting member surrounds the framed structure for contacting the dental tissues of a user. The teeth contacting member has the ability to resiliently flex and can be conveniently formed of a silicon rubber material which has an ability to flex and deform and has some resilience such that it will tend to return to its original form once the flexing force is removed. Further silicon rubber is soft and has some ability to conform to a surface against which it bears much like a cushion. It is therefore soft and comfortable when bearing against the gum tissues and teeth of a user. In the illustrated embodiment medical grade silicon rubber is used for the teeth contacting member that is approved for use on medical devices and can be purchased readily as a polymer.

The appliance 1 can be manufactured by the following method. The framed structure 71 is moulded from a polymeric material such as a polyamide in a first mould in an injection moulding operation. Thereafter the first mould is removed and replaced with a second mould and the teeth contacting member of silicon rubber is moulded onto the framed structure 71 in a second injection moulding operation. The mounting arrangement 3 is moulded directly onto the framed structure 71 in a process that is known as dual moulding. The final appliance 1 can be formed in two moulding operations and thus minimal labour and manual effort is required to manufacture the appliance.

The entire mounting arrangement 3 including the outer wall 7 forming the outer spacing formation 5 and the tongue elevator 51 is formed integrally in the second injection moulding operation. Further other features such as the cutaways 57, 59, 61 on the inner and outer walls 9, 7 and the tongue tab 63 and the breathing apertures 67 are also formed integrally in the second injection moulding operation. The appliance 1 can be manufactured in three to five different sizes with a corresponding number of different sized moulds and the applicant envisages that these sizes will be able to be used on the overwhelming majority of patients within the general population.

In use the appliance 1 can be used by a treatment provider that is a dental practitioner to treat dental malocclusions, particularly class 3 occlusions. Generally the appliance 1 will be used on patients showing the initial signs of Class 3 occlusion while they are still in the developmental stages of arch growth and arch formation. Generally this is the age group of 8-14 years. The treatment is commenced by an inspection of the dental occlusion of the patient by the dentist. The dentist will record the bite of the patient at the commencement of treatment by taking bite impressions and building a bite model of the upper and lower arches of a patient.

The dentist then selects a certain size of appliance from the range of sizes and fits it in position in a user's mouth. If necessary the dentist then tries appliances of different sizes until they identify the appliance size that best fits the patient. The appliance 1 does not require any moulding, e.g. by heating in boiling water, to fit it to the specific contours of a patient's mouth. The silicon outer layer is reasonable soft and conformable to some extent and the appliance 1 can generally be worn without discomfort.

As illustrated in FIGS. 19 to 25, the teeth of an upper arch 85 of a user are received in the upper channel 21 and the teeth of the lower arch 87 are received in the lower channel 21. FIG. 19 shows a side view and FIG. 20 shows a top plan view of the upper arch 85 and teeth received within the upper channel 21. FIGS. 23 to 25 show a section that is taken through a midline of the appliance 1 and a front region of the appliance 1. As shown the outer wall upper portion 13 holds the buccal mucosa of the user away from the upper arch 85 and gums of the user. There is a space between the upper arch 85 and the outer wall upper channel surface 33 so that no pressure is applied to the buccal surfaces of the arch tissues of a user.

FIG. 21 shows a section through a user's mouth and through an appliance 1 mounted in position in the user's mouth. The section is taken through a midline of the appliance 1 and thus it shows a front region of the member 3. As shown the outer wall upper outer wall portion 13 holds the buccal mucosa of the user spaced away from the upper arch 85 and gums of the user.

FIG. 21 also shows the position of the tongue 89 of the user being raised by the tongue elevator 51 on the lower portion of the inner wall 19. The drawing clearly shows how the elevator 51 elevates the position of the tongue 89 to a height within the mouth where it does not have a developmental influence on the bone growth of the lower arch 87.

FIG. 22 shows a rear view of the appliance 1 with the user's mouth tissues in the molar region being shown in section. The drawing shows a space between the gums over the teeth of the upper arch 85 and the outer wall upper channel surface 33 so that no pressure is being applied to the buccal surface of the upper arch tissues to inhibit bone growth of the upper arch.

Further these drawings show how the upper and lower channels 21, 23 are held in fixed position relative to each other to encourage the upper and lower arches 85, 87 that are received in these channels to adopt the correct relative position to each other for correct dental occlusion.

The tongue 89 is positioned above the lower arch 87 so that it does not stimulate further growth and development of the lower arch 87. Further by holding the buccal mucosa 91 away from the upper arch tissues so that it does not apply an inward pressure thereto, the upper arch 86 is permitted to develop and expand.

During treatment the patient will be directed to wear the appliance 1 for several hours a day and particularly at night time. At periodic intervals the dentist checks on the progress of the treatment. Over the time the upper arch 85 is encouraged to develop and expand to match the lower arch 87. In particular the width of the arch 85 in the molar regions should expand. Further the anterior incisor region of the upper arch 85 should develop in an anterior direction to develop the mid facial region at the same time that the width of the arch 85 is expanding.

After some time the incisors 93 of the lower arch 87 should be received behind the incisors 95 of the upper arch 85. This is an important stage in the treatment because then the upper arch incisors 95 tend to hold the incisors of the lower arch 93 in their position and counter balance any outward force on the lower arch 87.

The treatment is complete when the incisors of the upper arch are about 1.5 mm to 2 mm in front of the incisors of the lower arch as shown in FIG. 1. Further a portion of each molar on the upper arch 87 should be positioned outside of the corresponding molar of the lower arch 85 as shown in FIG. 2. The progression of treatment of this malocclusion is shown in FIGS. 23 to 25.

Once the class 3 occlusion has been corrected the appliance may be worn for shorter periods but may still be worn regularly to maintain the correct dental occlusion. Thus it acts as both an active and a passive orthodontic appliance.

Two examples of patients who were successfully treated using the method and the appliance disclosed in this application are described below. Each of the treated patients were in the age group of 5 to 8 years where the dental arches and the adult teeth are developing.

In the first example, a female patient aged 5 to 8 years presented with a severe class 3 malocclusion during the eruptive phase of the development of her teeth. A set of clinical photographs providing a visual depiction of the arch forms and dentition was taken by the treatment professional prior to the commencement of treatment in October 2006. FIGS. 26 to 28 are schematic drawings of these clinical photographs. The incisors of the lower arch are positioned anteriorly to the incisors on the upper arch.

Thereafter treatment was commenced by an orthodontic professional with an i-3 interceptive appliance produced by the Myofunctional Research Corporation Pty Ltd. This appliance is substantially identical to the appliance illustrated in FIGS. 6 to 11 of the drawings of the patent application. The progress of treatment was monitored by the orthodontic professional through appointments held at 6 to 8 week intervals. The patient was instructed to wear the appliance for at least 8 hours a day including at night time. The orthodontic professional noted that compliance by this patient was good.

The progress of the treatment was measured by the orthodontic professional in March 2008 and line drawings of the clinical photographs of the arch forms and dentition at this time are shown in FIGS. 29 to 31. A noticeable improvement in the class 3 malocclusion is evident in these drawings. The protrusion of the lower jaw has been significantly reduced and there has been some development of the mid facial region of the upper arch. The incisors of the upper and lower arches are broadly aligned with each other, which is a significant improvement over the start of the treatment, although the lower arch incisors are not received behind the upper arch incisors.

The progress of treatment was again measured by the orthodontic professional in August 2008 and drawings of the clinical photographs showing development of the arch form and the dentition are shown in FIGS. 32 and 33. In these drawings the class 3 malocclusion has been substantially corrected with the incisors of the lower arch received behind the upper incisors (i.e. the reverse of their positions at the commencement of treatment). The teeth on both the upper and lower arch are reasonably well aligned with each other. Further the incisor on the upper arch has developed to its full size. Thus the treatment program effectively corrected the class 3 malocclusion over a treatment period of 22 months. The patient was monitored post August 2008 and no relapse was observed. The patient continued to wear the appliance for a reduced amount of time each day in the post treatment period to maintain correct dental occlusion.

In the second example a male patient in Australia aged 5 to 8 years presented with a severe class 3 malocclusion during the development of his teeth.

A set of clinical photographs providing a visual depiction of the arch forms and dentition was obtained at the commencement of treatment on 2 Apr. 2009. These photographs are reproduced in FIGS. 34 to 36. The incisors of the lower arch are positioned anterior to the incisors of the upper arch.

Thereafter treatment was commenced by an orthodontic professional with an i-3 interceptive appliance produced by the Myofunctional Research Corporation Pty Ltd. The progress of treatment was monitored by the orthodontic professional through appointments held at 6 to 8 week intervals. The patient was instructed to wear the appliance for at least 8 hours a day including at night time and patient compliance appeared to be good.

The efficacy of the treatment was measured by the orthodontic professional in April 2012 and pictures of the development of the arch form and the dentition are shown in FIGS. 37 to 39. In these pictures the class 3 malocclusion has been substantially corrected with the incisors of the lower arch received behind the upper incisors as is required for correct dental occlusion.

Thus the treatment program effectively corrected the class 3 malocclusion over a treatment period of 36 months. The patient was monitored post April 2012 and no relapse was observed. The patient continued to wear the appliance for a reduced amount of time each day in the post treatment period to ensure there was no relapse.

Without being bound by the statement Applicant believes that at least 70% of patients that have been treated for Class 3 malocclusions in his clinics have been successful treated with results that are comparable to those in the examples above. Without being bound by the statement Applicant believes that a lack of patient compliance is a major factor in those treatments that are not successful.

Thus the appliance described above with reference to the drawings works at several different levels simultaneously to help correct a class 3 malocclusion. In particular it relieves the pressure of the buccal mucosa against the upper arch tissues along the full extent of the arch and elevates the tongue position so that it does not apply pressure to the lower arch whereby to stimulate development of the bone structures of the lower arch.

In particular the outer wall of the appliance and particularly the upper portion of the outer wall forms an outer spacing formation that holds the buccal mucosa and associated soft tissues in the cheek of the user spaced away from the outer surface of the upper arch. The stiffness of the outer wall provides the necessary strength to hold the buccal mucosa away from the tissues of the upper arch. By removing the force of the soft tissues bearing against the arch a force inhibiting development of the upper arch is removed and this encourages upper arch development. A further advantage is that by having a continuous outer wall that extends along the full incisor, canine and molar regions, the application of an inward pressure along the full length of the upper arch is alleviated. This encourages the full length of the upper arch including the mid facial region to develop and grow simultaneously.

A further advantage of the appliance described above with reference to the drawings is that it has a tongue elevating formation that raises the position of the tongue in the mouth so that it bears against the anterior incisor teeth of the upper arch and not the incisor teeth of the lower arch. The pressure of a tongue bearing against the incisor teeth of the lower arch promotes development of the lower arch and may cause overdevelopment of the lower arch relative to the upper arch. By repositioning the tongue so that it does not bear against the teeth of the lower arch, the force stimulating lower arch growth and development is removed.

A further advantage of the mounting arrangement and the outer wall is that it has an ability to resiliently flex out of a desired arch form while still retaining a good memory. Thus when the mounting arrangement is moved or flexed out of its resting arch form it will exert a return force tending to return the arch to its original resting form. This can apply an outward force to the upper arch encouraging it to expand outwardly.

An advantage of the resilient flexibility of the mounting arrangement with the inner and outer walls and the web is that it can be fitted to users having different arch sizes and different teeth sizes. A further advantage of the appliance described above is that notwithstanding its stiffness and resilient strength, the surface of the appliance that contacts the teeth and gum tissues is soft and conformable and is comfortable against the gums of a user. This is important if the appliance is to be worn by a user when they sleep at night.

A yet further advantage of the appliance described above is that it has upper and lower channels for forcing the upper and lower arches of a user to take up the correct positions relative to each other when the appliance is worn by a user. This promotes and encourages the arches to adopt the correct relative position to each other which is an important part of correct dental occlusion.

A yet further advantage of the appliance described above is that the upper and lower channels and particularly the outer channel surfaces thereof are off-set relative to each other by 0.5 mm to 2.0 mm, e.g. 1.0 mm to 1.5 mm to replicate correct dental occlusion. That is the teeth of the upper arch are positioned outwardly of the corresponding teeth of the lower arch. Consequently in the final stages of treatment the appliance will tend to move the teeth to the point where the teeth of the lower arch are correctly set back from those of the upper arch bringing them into a position representing correct dental occlusion.

A further advantage of the appliance described above with reference to the drawings is that it can be formed by injection moulding. The features of the teeth mounting arrangement described above can be moulded integrally with the rest of the teeth contacting member. By forming the structural features integrally with the rest of the teeth contacting member, a manufacture of the appliance is simplified. The internal framed structure can be injection moulded in a first step and then the teeth contacting member may be moulded onto the base member in a second injection moulding step. These features also enable the appliance to be manufactured on a commercial scale so that it can be supplied as an off the shelf item. Applicant envisages that it will be made with three different arch sizes and these arch sizes will be able to be fitted to most users. The appliance does not need to be custom moulded to fit the mouth of each patient in a dental laboratory and as a result the technology can be provided at a lower cost and be made more accessible to the patient population at large.

It will of course be realised that the above has been given only by way of illustrative example of the disclosure and that all such modifications and variations thereto, as would be apparent to persons skilled in the art, are deemed to fall within the broad scope and ambit of the disclosure as is herein set forth.

What is claimed is:

1-31. (canceled)

32. An orthodontic appliance for treating a class 3 malocclusion in a patient having an upper and a lower arch, the appliance comprising:
an outer wall, an inner wall, and a web, wherein:
the web extends between the outer wall and the inner wall to form a lower web surface and an upper web surface;
the outer wall, inner wall and web define an upper channel within which the upper arch can be received and a lower channel within which the lower arch can be received;
the outer wall and the inner wall form a mounting arrangement for mounting the appliance on the upper and lower arches;
the outer wall has an upper portion above the web defining an outer wall upper channel surface and a lower portion below the web defining an outer wall lower channel surface;
the upper web surface has a greater width between the inner and outer walls than the lower web surface;
the outer wall upper channel surface is vertically off-set from the outer wall lower channel surface across the patient's canines and incisors, with the outer wall lower channel surface set back from the outer wall upper channel surface; and
the upper portion of the outer wall is configured to hold the patient's buccal mucosa spaced away from the upper arch, and the width of the upper web surface accommodates development of the upper arch during treatment; and
the orthodontic appliance further comprises a tongue elevator positioned beneath the lower web surface, the tongue elevator being configured to force the patient's tongue up to a height above the lower arch.

33. An orthodontic appliance according to claim 32, wherein the outer and inner walls include a frontal incisor region configured to extend across the patient's incisors, and canine and molar regions on each side of the frontal incisor region configured to extend across the patient's canines and molars respectively in the form of two arms extending rearward from the frontal incisor region, and the outer wall lower channel surface is set back from the outer wall upper channel surface along at least the incisor and canine regions of the outer and inner walls.

34. An orthodontic appliance according to claim 32, wherein the lower portion of the outer wall is configured to closely fit the patient's teeth and lower arch so as to assist in mounting the appliance.

35. An orthodontic appliance according to claim 32, wherein the outer wall lower channel surface is set back from the outer wall upper channel surface by a distance of 0.5 mm to 2.0 mm.

36. An orthodontic appliance according to claim 35, wherein the outer wall lower channel surface is set back relative to the outer wall upper channel surface by a distance of 1.0 mm to 1.5 mm.

37. An orthodontic appliance according to claim 32, wherein the outer wall upper channel surface extends upward away from the upper web surface at an angle of 80 degrees to 100 degrees.

38. An orthodontic appliance according to claim 36, wherein the outer wall upper channel surface extends upward away from the upper web surface at an angle of 85 to 90 degrees.

39. An orthodontic appliance according to claim 32, wherein the outer wall includes a buccal outer surface facing away from the channels, and an upper portion of the buccal outer surface is substantially vertically extending when fitted on the patient, and a lower portion of the buccal outer surface extends at an angle of 2 to 10 degrees to a line passing through the upper portion of the buccal outer surface.

40. An orthodontic appliance according to claim 32, wherein the outer wall upper channel surface extends to a height of 11 to 15 mm above the upper web surface along substantially a full length of the appliance.

41. An orthodontic appliance according to claim 32, wherein the inner wall has an upper portion above the web and a lower portion below the web and the upper portion defines an inner wall upper channel surface and the lower portion below the web defines an inner wall lower channel surface.

42. An orthodontic appliance according to claim 41, wherein, the inner wall upper channel surface is arranged and positioned so that it bears up against the teeth and upper arch of the patient.

43. An orthodontic appliance according to claim 41, wherein the lower portion of the inner wall has a terminal edge region, and an upper surface of the terminal edge region forms the tongue elevator.

44. An orthodontic appliance according to claim 43, wherein a part of the terminal edge region of the inner wall is enlarged and the enlarged part forms the tongue elevator.

45. An orthodontic appliance according to claim 43, wherein the tongue elevator formed by the upper surface of the terminal edge region is a vertical distance of 2 mm to 6 mm beneath the lower web surface.

46. An orthodontic appliance according to claim 45, wherein the tongue elevator is a vertical distance of 3 mm to 5 mm beneath the lower web surface.

47. An orthodontic appliance according to claim 32, wherein the outer and inner walls are resiliently flexible which enables the appliance to be fitted to a patient when the upper and and lower arches do not match the upper and lower channels of the appliance by deforming the outer and inner walls to receive the upper and lower arches in the upper and lower channels.

48. An orthodontic appliance according to claim 47, wherein the upper and lower channels are formed with a predetermined arch form so that when the appliance is applied to a patient having an underdeveloped upper arch, the outer and inner walls and the web are resiliently flexed out of their original resting position and as a result a return force is applied to the upper arch of the patient for promoting expansion of the upper arch.

49. An orthodontic appliance according to claim 32, further comprising:
a teeth contacting member forming the outer wall, the inner wall and the web, the teeth contacting member being formed of a cushioning material for cushioning the appliance against the teeth and gums of the patient; and
a base member encased within the teeth contacting member for conferring a suitable level of structural stiffness on the appliance while still permitting some resilient flexing thereof.

50. An orthodontic appliance according to claim 49, wherein the base member comprises a frame structure that is resiliently flexible, the frame structure including a frame web portion that is broadly coextensive with the web, and a frame wall portion projecting substantially orthogonally up from the frame web portion for conferring sufficient stiffness on the outer wall to hold the buccal mucosa away from the upper arch while the appliance is being worn.

51. An orthodontic appliance according to claim 50, wherein the frame wall portion comprises an upper wall frame section above the frame web portion and a lower wall frame section below the frame web portion, and the lower wall frame section is set back from the upper wall frame section.

52. An orthodontic appliance according to claim 51, wherein the lower wall frame section is set back from the upper wall frame section by a distance of 0.5 mm to 2.00 mm.

53. An orthodontic appliance according to claim 50, wherein the frame wall portion is broadly coextensive with the outer wall.

54. An orthodontic appliance for treating a class 3 malocclusion in a patient having an upper and a lower arch, the appliance comprising:
an outer wall, an inner wall, and a web extending between the inner and the outer walls to form a lower web surface and an upper web surface, wherein:
the outer wall, inner wall and web define an upper channel within which the upper arch can be received and a lower channel within which the lower arch can be received, the outer and inner walls include a frontal incisor region is configured to extend across the patient's incisors, and canine and molar regions on each side of the frontal incisor region are configured to extend across the patient's canines and molars;
the inner wall has an upper portion above the web and a lower portion below the web;
the outer wall has an upper portion above the web defining an outer wall upper channel surface and a lower portion below the web defining an outer wall lower channel surface;
the upper web surface has a greater width between the inner and outer walls than the lower web surface;
the outer wall upper channel surface is vertically off-set from the outer wall lower channel surface with the outer wall lower channel surface set back from the outer wall upper channel surface by a distance of 0.5 mm to 2.0 mm along at least the incisor and canine regions;
the upper portion of the outer wall holds the patient's buccal mucosa spaced away from the patient's upper arch and the width of the upper web surface accommodates development of the upper arch during treatment;
the outer wall and the inner wall form a mounting arrangement for mounting the appliance on the upper and lower arches, and the lower portion of the outer wall is configured to fit closely to the teeth and lower arch of the patient; and
the orthodontic appliance further comprises a tongue elevator positioned beneath the lower web surface, the tongue elevator being configured to force the patient's tongue up to a height above the lower arch, wherein the lower portion of the inner wall has a terminal edge region having an upper surface of the terminal edge region forming said tongue elevator having a vertical distance of 2 mm to 6 mm beneath the lower web surface.

55. An orthodontic appliance for treating a class 3 malocclusion in a patient having an upper and a lower arch, the appliance comprising a teeth contacting member, a tongue elevator, and a base member, wherein:
the teeth contacting member comprises:
an outer wall and an inner wall, and a web extending between the inner and the outer walls forming a lower web surface and an upper web surface, the outer wall, inner wall and web defining an upper channel within which the upper arch can be received and a lower channel within which the lower arch can be received, wherein:
the outer wall and the inner wall form a mounting arrangement for mounting the appliance on the upper and lower arches;
the outer wall has an upper portion above the web defining an outer wall upper channel surface and a lower portion below the web defining an outer wall lower channel surface;
the upper web surface has a greater width between the inner and outer walls than the lower web surface;
the outer wall upper channel surface is vertically off-set from the outer wall lower channel surface with the outer wall lower channel surface set back from the outer wall upper channel surface along at least incisors and canines of the upper arch
the upper portion of the outer wall holds the patient's buccal mucosa spaced away from the upper arch and the width of the upper web surface accommodates development of the upper arch during treatment; and
the teeth contacting member formed of a cushioning material for cushioning the appliance against the teeth and gums of the patient; and
the tongue elevator is positioned beneath the lower web surface for forcing the patient's tongue up to a height above the lower arch; and
the base member comprises a frame structure that is resiliently and flexibly encased by the teeth contacting member for conferring a suitable level of structural stiffness on the appliance while still permitting some resilient flexing thereof, wherein:
the frame structure includes a frame web portion that is broadly coextensive with the web, and a frame wall portion projecting substantially orthogonally up from the frame web portion for conferring sufficient stiffness on the outer wall to hold the buccal mucosa away from the upper arch while the appliance is being worn; and
the frame wall portion comprises an upper wall frame section above the frame web portion and a lower wall frame section below the frame web portion which is offset back from the upper wall frame section;
further wherein the outer and inner walls of the appliance are resiliently flexible so as to enable the appliance to be fitted to the patient when the upper and lower arches do not match the upper and lower channels of the appliance by deforming the outer and inner walls to receive the upper and lower arches in the upper and lower channels.

56. An orthodontic appliance according to claim 55, wherein the lower wall frame section is set back from the upper wall frame section by a distance of 0.5 mm to 2.00 mm.
